(19) United States
(12) Patent Application Publication
(10) Pub. No.: US 2024/0015649 A1
(43) Pub. Date: Jan. 11, 2024

(54) MULTI-LINK TARGET WAKE TIME (TWT)

(71) Applicant: Apple Inc., Cupertino, CA (US)

(72) Inventors: Jarkko L. KNECKT, Los Gatos, CA (US); Mohamed ABOUELSEOUD, Burlingame, CA (US); Oren SHANI, Saratoga, CA (US); Anuj BATRA, Redwood City, CA (US); Yoel BOGER, Shoham (IL); Yong LIU, Campbell, CA (US); Leonid EPSTEIN, Herzliya (IL); Su Khiong YONG, Palo Alto, CA (US); Qi WANG, Sunnyvale, CA (US); Zhou LAN, San Jose, CA (US); Tianyu WU, Monterey, CA (US); Akira YAMANAKA, Sunnyvale, CA (US); Noam GINSBURG, Haifa (IL)

(73) Assignee: Apple Inc., Cupertino, CA (US)

(21) Appl. No.: 18/219,523

(22) Filed: Jul. 7, 2023

Related U.S. Application Data
(60) Provisional application No. 63/367,967, filed on Jul. 8, 2022.

(51) Int. Cl. H04W 52/02; H04W 76/15

(52) U.S. Cl. CPC H04W 52/0216; H04W 76/15; H04W 84/12

(57) ABSTRACT

Some aspects include apparatuses and methods for implementing a target wake time (TWT) scheme (or technique) for multi-link wireless communication networks. For example, a multi-link device (MILD) includes a first station (STA) associated with a first link of a wireless network and configured to communicate with a second MLD over the first link using a multi-link target wake time (TWT) process. The MLD also includes a second STA associated with a second link of the wireless network and configured to communicate with the second MLD over the second link using the multi-link TWT process. The MLD further includes one or more processors communicatively coupled to the first and second STAs and configured to control the operations of the first and second STAs to perform the multi-link TWT process.

### CROSS-REFERENCE TO RELATED APPLICATIONS

The present application claims the benefit of U.S. Provisional Patent Application No. 63/367,967, filed on Jul. 8, 2022, which is hereby incorporated by reference in its entirety.

### BACKGROUND

### Field

The described aspects generally relate to channel access in wireless communications, including to a multi-link target wake time in multi-link wireless communication networks, such as a wireless local area network (WLAN).

### Related Art

Target wake time (TWT) is a power saving mechanism that can be used with communication techniques compatible with Institute of Electrical and Electronics Engineers (IEEE) 802.11 standards. For example, the TWT scheme (or technique) can be used within a single-link WLAN. In the example of the single-link WLAN, an access point (AP) and one or more stations (STAs) can negotiate a specific time or a set of times for the stations to access a medium. The TWT scheme can be used to control the amount of contention over the medium by allowing the station to set up a periodic active/sleep (power save) schedule with the access point. Using the TWT scheme, the station does not need to send explicit power save and active transition notifications to the access point, which was traditionally done through, for example, setting a power management (PM) indication bit in a media access control (MAC) header of a MAC frame.

The WLAN can also include multi-link communication using multi-link devices. For example, a first multi-link device (MLD) can communicate with a second MLD using a plurality of links/channels. For example, the first MLD can use a first radio to communicate with a first radio of the second MLD using a first link. The first MLD can also use a second radio to communicate with a second radio of the second's MLD using a second link. The two MLDs can communicate more data and/or communicate the data faster using multiple links. However, the MLDs will use more power when two radios are being used.

### SUMMARY

Some aspects of this disclosure include apparatuses and methods for implementing a target wake time (TWT) scheme (or technique) for multi-link wireless communication networks such as a wireless local area network (WLAN). The TWT scheme/process for multi-link WLAN can assist the devices in the WLAN (e.g., an access point (AP), a station (STA)) to better utilize channel resources and to save power in the multi-link WLAN.

Some aspects relate to a multi-link device (MLD). The MLD includes a first station (STA) associated with a first link of a wireless network and configured to communicate with a second MLD over the first link using a multi-link target wake time (TWT) process. The MLD also includes a second STA associated with a second link of the wireless network and configured to communicate with the second MLD over the second link using the multi-link TWT process. The MLD further includes one or more processors communicatively coupled to the first and second STAs. The one or more processors are configured to receive, using the first STA on the first link, an initial control frame during a first service period (SP) associated with the multi-link TWT process. The one or more processors are further configured to transmit, using the first STA on the first link, a response to the initial control frame to indicate an availability of the first STA on the first link during the first SP and to indicate an availability of the second STA on the second link during a second SP associated with the multi-link TWT process. The second SP can be substantially synchronized with the first SP.

In some implementations, the one or more processors are further configured to receive, using the first STA on the first link, a trigger frame from the second MLD during the first SP and transmit, using the first STA on the first link, a data frame to the second MLD during the first SP.

In some implementations, the one or more processors are further configured to receive, using the second STA on the second link, a second initial control frame during the second SP. The one or more processors are further configured to transmit, using the second STA on the second link, a second response to the second initial control frame to indicate an availability of the second STA on the second link during the second SP. The one or more processors are further configured to receive, using the second STA on the second link, a second data frame from the second MLD during the second SP.

In some implementations, the response to the initial control frame indicates that the second STA on the second link is unavailable. The one or more processors are further configured to receive, using the first STA on the first link, a second initial control frame during the first SP and transmit, using the first STA on the first link, a second response to the second initial control frame to indicate the availability of the first STA on the first link. The one or more processors are further configured to receive, using the first STA on the first link, a second data frame from the second MLD during the first SP.

In some implementations, the one or more processors are further configured to receive, using the first STA on the first link, a trigger frame from the second MLD during the first SP and transmit, using the first STA on the first link, a data frame to the second MLD during the first SP. The data frame can include a TWT information frame indicating the availability of the first STA during a rest of the first SP and the availability of the second STA during a rest of the second SP.

In some implementations, the one or more processors are further configured to receive, using the first STA on the first link, a trigger frame from the second MLD during the first SP and transmit, using the first STA on the first link, a data frame to the second MLD during the first SP. The data frame can include a TWT information frame indicating one or more SPs associated with the multi-link TWT process after the first SP are suspended.

In some implementations, the one or more processors are further configured to receive, using the first STA on the first link, a data frame from the second MLD during the first SP. The one or more processors are further configured to determine that an End Of Service Period (EOSP) field in a media access control (MAC) header associated with a last one of one or more packets of the data frame is set to a first value to indicate that no more packets will be transmitted within the first SP. In response to the determination, the one or more processors are further configured to transition the first STA and the second STA to a power save mode.

In some implementations, the one or more processors are further configured to receive, using the first STA on the first link, a data frame from the second MLD during the first SP. The data frame can include a TWT information frame indicating that the second MLD is unavailable on the first link. In response to the reception of the TWT information frame, the one or more processors are further configured to transition the first STA to a power save mode.

In some implementations, the MLD is operating in an enhanced multi-link single radio (EMLSR) operation mode, a simultaneous transmit and receive (STR) operation mode, or a non-simultaneous transmit and receive (NSTR) operation mode. In some aspects, the second STA is unavailable, uses a low power receive radio, or is unavailable for downlink (DL) data on the second link at least while the first STA transmits the response to the ICF frame.

In some implementations, the one or more processors are further configured to receive, using the first STA on the first link, a first data frame from the second MLD during the first SP and receive, using the second STA on the second link, a second data frame from the second MLD during the second SP. The one or more processors are further configured to determine that a first End Of Service Period (EOSP) field in a first media access control (MAC) header associated with a last one of one or more packets of the first data frame is set to a first value to indicate that no more packets will be transmitted within the first SP and transition the first STA to a power save mode. The one or more processors are further configured to determine that a second EOSP field in a second MAC header associated with a last one of one or more packets of the second data frame is set to the first value to indicate that no more packets will be transmitted within the second SP and transition the second STA to the power save mode.

In some implementations, the multi-link TWT process includes the SP associated with the first link and the second SP. A time duration for the first SP and the second SP can be determined based on a first quality of service of the first link and a second quality of service of the second link.

Some aspects relate to a method that includes receiving, using a first station (STA) of a first multi-link device (MLD) and on a first link of a wireless network, an initial control frame from a second MLD during a first service period (SP) associated with a multi-link target wake time (TWT) process. The first MLD further includes a second STA associated with a second link of the wireless network and configured to communicate with the second MLD over the second link using the multi-link TWT process. The method further includes transmitting, using the first STA on the first link, a response to the initial control frame to indicate an availability of the first STA on the first link during the first SP and to indicate an availability of the second STA on the second link during a second SP associated with the multi-link TWT process. The second SP can be substantially synchronized with the first SP.

Some aspects relate to a non-transitory computer-readable medium storing instructions. When the instructions are executed by a processor of a multi-link device (MLD), the instructions cause the processor to perform operations including receiving, using a first station (STA) of the MLD and on a first link of a wireless network, an initial control frame from a second MLD during a first service period (SP) associated with a multi-link target wake time (TWT) process. The MLD further includes a second STA associated with a second link of the wireless network and configured to communicate with the second MLD over the second link using the multi-link TWT process. The operations further include transmitting, using the first STA on the first link, a response to the initial control frame to indicate an availability of the first STA on the first link during the first SP and to indicate an availability of the second STA on the second link during a second SP associated with the multi-link TWT process. The second SP can be substantially synchronized with the first SP.

This Summary is provided for purposes of illustrating some aspects to provide an understanding of the subject matter described herein. Accordingly, the above-described features are only examples and should not be construed to narrow the scope or spirit of the subject matter in this disclosure. Other features, aspects, and advantages will become apparent from the following Detailed Description, Figures, and Claims.

### BRIEF DESCRIPTION OF THE FIGURES

The accompanying drawings, which are incorporated herein and form part of the specification, illustrate the present disclosure and, together with the description, further serve to explain the principles of the disclosure and enable a person of skill in the relevant art(s) to make and use the disclosure.

FIG. 1A illustrates an example system implementing the TWT scheme in a multi-link communication network, according to some aspects.

FIG. 1B illustrates an example multi-link communication between two devices, according to some aspects.

FIG. 2 illustrates a block diagram of an example wireless system of an electronic device implementing the TWT scheme for multi-link communication network, according to some aspects.

FIG. 3 illustrates an exemplary communication between an access point (AP) multi-link device (MLD) and a non-AP MLD implementing the TWT scheme in a multi-link communication network, according to some aspects.

FIG. 4 illustrates an exemplary TWT flow, according to some aspects.

FIG. 5 illustrates an exemplary multi-link TWT flow for two links, according to some aspects.

FIG. 6 illustrates an exemplary multi-link TWT flow for two links with service period canceling, according to some aspects.

FIGS. 7A-7C illustrate exemplary multi-link TWT flows and TWT information frame for controlling the availability of STAs on the links of the multi-link TWT, according to some aspects.

FIG. 8 illustrates an exemplary multi-link TWT flow for suspending and/or resuming link specific TWT flows, according to some aspects.

FIG. 9 illustrates an exemplary multi-link TWT flow for two links with initial control frame (ICF) frame having additional padding, according to some aspects.

FIG. 10A illustrates an exemplary multi-link TWT flow with End of Service Period (EOSP), according to some aspects.

FIG. 10B illustrates an exemplary multi-link TWT flow with a TWT information frame to signal service period termination, according to some aspects.

FIG. 11 illustrates an exemplary multi-link TWT flow for two links for simultaneous transmit and receive (STR) stations (STAs), according to some aspects.

FIG. 12 illustrates an exemplary multi-link TWT flow with End of Service Period (EOSP), according to some aspects.

FIG. 13 illustrates an example method for a wireless system supporting and implementing a multi-link TWT scheme/process for multi-link wireless communication networks, according to some aspects.

FIG. 14 is an example computer system that can be used for implementing some aspects or portion(s) thereof.

The present disclosure is described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

Some aspects of this disclosure include apparatuses and methods for implementing a target wake time (TWT) scheme (or technique) for multi-link wireless communication networks such as a wireless local area network (WLAN). The TWT scheme/process for multi-link WLAN can assist the devices in the multi-link WLAN (e.g., an access point (AP), a station (STA)) to better utilize channel resources and to save power.

According to some aspects, the TWT scheme for multi-link WLAN can be implemented with communication techniques compatible with Institute of Electrical and Electronics Engineers (IEEE) 802.11 standards (such as, but not limited to IEEE 802.1 lac, IEEE 802.11ax, IEEE 802.11bc, IEEE 802.11bd, IEEE 802.11be, etc.). However, the aspects of this disclosure can also be extended to operations in other multi-link communication networks.

TWT (e.g., TWT for a single-link communication network) is a mechanism that enables, for example, an electronic device (e.g., an access point) to negotiate and/or define a specific time or a set of times for other electronic devices (e.g., a station) to access a medium. After a TWT schedule is configured, the access point (AP) can transmit packets to and/or receive packets from the station (STA) during scheduled period(s). Accordingly, the station can be awake during the scheduled periods to transmit and/or receive the packets and can be asleep or perform other activities outside of the scheduled periods.

As discussed in more detail below, the TWT scheme (for a single-link wireless network and/or for a multi-link wireless network) can include a TWT start time indicating when the TWT scheme starts. The TWT scheme can include one or more service periods (SP) that are time windows that where the stations will be awake (e.g., in active mode) because the stations may transmit and/or receive packets during these service periods. Each service period may have a service period start time, a service period end time, and/or a service period duration. The service periods can have the same or different time durations. The TWT scheme can further include one or more repetition intervals. The repetition interval may be the interval between the respective start times of consecutive service periods. In some aspects, when a TWT service period is not ongoing, the station(s) can be asleep (e.g., power save mode) or can perform other activities as the stations(s) does not expect to transmit and/or receive packets associated with this TWT scheme.

According to some aspects, the current TWT scheme for multi-link wireless communication networks (also referred herein as multi-link TWT scheme or multi-link TWT process) includes complicated TWT SP scheduling, where multi-link TWT flows can include cross-link sharing that can further complicate the TWT SP scheduling. According to some aspects, multi-link transmissions (e.g., using an enhanced multi-link single radio (EMLSR) operation mode or a simultaneous transmit and receive (STR) operation mode) can reduce transmission latency and improve reliability. However, multi-link operation rules (e.g., for EMLSR, STR operation modes) for the simultaneous TWT SPs are currently not provided. Some aspects proved exemplary multi-link operation rules (e.g., for EMLSR, STR operation modes) for the simultaneous TWT SPs. For example, the multi-link TWT SP handling with EMLSR and STR transmissions are provided. Additionally, multi-link TWT SP control by using, for example, TWT information frame, or other signaling, are provided.

According to some aspects, the TWT scheme for multi-link wireless communication networks can include an individual TWT scheme, a broadcast TWT scheme, and/or a restricted TWT (rTWT) scheme for multi-link wireless communication networks. In some aspects, the individual TWT scheme for multi-link wireless communication networks can include a TWT scheme where a first multi-link device (MLD) (e.g., an AP MLD) (or an AP of the AP MLD) can communicate and negotiate with a second MLD (e.g., a non-AP MLD) (or a STA of the non-AP MLD) to configure and set up the individual TWT scheme.

In some aspects, the broadcast TWT scheme for multi-link wireless communication networks can include a TWT scheme where the first MLD (e.g., the AP MLD) (or an AP of the AP MILD) can broadcast (or multicast) parameters of the TWT scheme to one or more second MLDs (e.g., non-AP MLDs) (or one or more STAs of the non-AP MLD) to configure and set up the broadcast TWT scheme. In some aspects, the information and parameters of the TWT scheme can be broadcasted (or multicasted) using one or more Beacons. In some implementations, the broadcast TWT scheme for multi-link wireless communication networks can be used to broadcast data to the one or more second MLDs.

According to some aspects, the restricted TWT (rTWT) scheme is similar to broadcast TWT scheme with some additional protections. Similar to the broadcast TWT scheme, in the rTWT scheme the first MLD (e.g., the AP MILD) (or an AP of the AP MLD) can broadcast (or multicast) parameters of the TWT scheme to one or more second MLDs (e.g., non-AP MILDs) (or one or more STAs of the non-AP MLD) to configure and set up the rTWT scheme.

In some aspects, in the rTWT, uplink transmissions (e.g., transmission from the non-AP MLDs to the AP-MLD) are stopped before each TWT SP starts. In these examples, the AP-MLD can have access to the medium for downlink transmission(s) during the TWT SPs. Additionally, or alternatively, the rTWT scheme for multi-link wireless communication networks can include a TWT scheme where the first MLD (e.g., the AP-MLD) can allocate exclusive access to the medium for one or more second MILDs (e.g., non-AP MILDs) at specified times. In some implementations, the restricted TWT scheme for multi-link wireless communication networks can allocate exclusive service period(s) for the one or more second MLDs.

According to some aspects, the TWT scheme for multi-link wireless communication networks can be used for an enhanced multi-link single radio (EMLSR) operation mode, a simultaneous transmit and receive (STR) operation mode, and/or a non-simultaneous transmit and receive (NSTR) operation mode.

According to some aspects, in the EMLSR operation mode, a STA can operate a low power receive radio. The STA may transmit on a single link, but when the STA is accessing a channel, is competing on uplink Enhanced Distributed Channel Access (EDCA), or is waiting for a trigger frame, the STA can receive the first indication frame on multiple links or do channel access competition on multiple links. In other words, in the EMLSR operation mode, the STA can be present on multiple links, but can transmit data on a single radio.

According to some aspects, in the STR operation mode, the STA can have multiple radios and can operate these multiple radios (and multiple links) independently. For example, the STA in the STR operation mode can be able to receive data on a first link (e.g., Link 1) and transmit data on a second link (e.g., Link 2).

According to some aspects, in the NSTR operation mode, the STA can transmit data on two (or more) links or receive data on two (or more links). However, the STA cannot transmit data on a first link (e.g., Link 1) and receive data on a second link (e.g., Link 2) simultaneously.

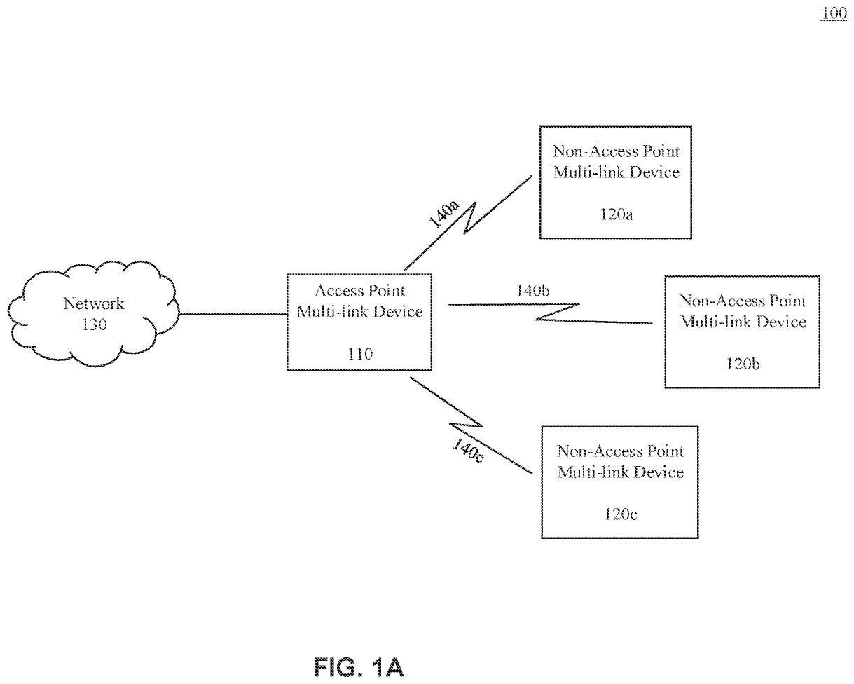

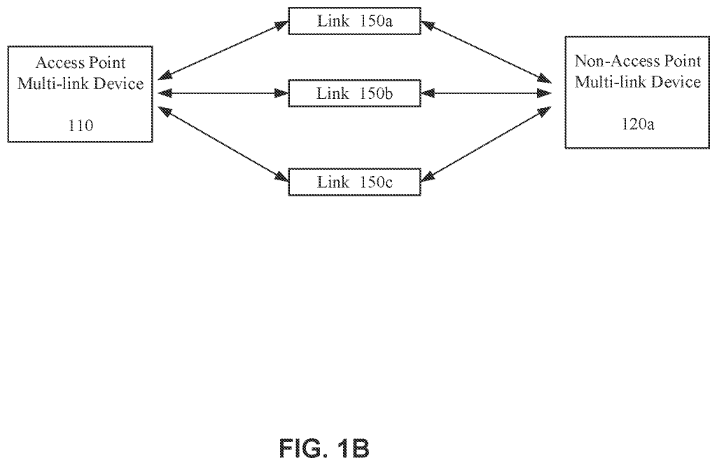

FIG. 1A illustrates an example system 100 implementing a TWT scheme in a multi-link communication network, according to some aspects. Example system 100 is provided for the purpose of illustration only and does not limit the disclosed aspects. System 100 may include, but is not limited to, an access point (AP) multi-link device (MLD) 110, a non-AP MLDs 120, and a network 130. The non-AP MLDs 120a-120c may include, but are not limited to, Wireless Local Area Network (WLAN) stations such as wireless communication devices, smart phones, laptops, desktops, tablets, personal assistants, monitors, televisions, wearable devices, and the like. The AP MLD 110 may include but is not limited to WLAN electronic devices such as a wireless router, a wearable device (e.g., a smart watch), a wireless communication device (e.g., a smart phone), or a combination thereof. Network 130 may be the Internet and/or a WLAN. The non-AP MLD 120's communications are shown as wireless communications 140. The communication between the AP MLD 110 and the non-AP MLD 120 can take place using wireless communications 140a-140c. The wireless communications 140a-140c can be based on a wide variety of wireless communication techniques. These techniques can include, but are not limited to, techniques based on IEEE 802.11 (such as, but not limited to IEEE 802.11ac, IEEE 802.11ax, IEEE 802.11bc, IEEE 802.11bd, IEEE 802.11be, IEEE 802.11v, etc. standards).

According to some aspects, the AP MLD 110 and the non-AP MLDs 120 are configured to implement a multi-link communication. In other words, the AP MLD 110 and the non-AP MLDs 120 are configured to implement and support simultaneous or substantially simultaneous data transfer using multiple MAC/PHY links. For example, FIG. 1B illustrates an example multi-link communication between two devices, according to some aspects.

As illustrated in FIG. 1B, the non-AP MLD 120a and the AP MLD 110 can communicate with each other using multiple links 150a-150c. In other words, the non-AP MLD 120a and the AP MLD 110 can use multiple MAC/PHY links 150a-150c to simultaneously or substantially simultaneously transfer data. Although three links 150 are illustrated, the aspects of this disclosure are not limited to this example and any number of links 150 can be implemented. The links 150 can include different wireless channels, according to some aspects. For example, each wireless channel/link 150 can be defined based on its respective frequency that is different from the others. However, the aspects of this disclosure are not limited to wireless channels and other MAC/PHY layer links can be used as links 150 for communication between the non-AP MLD 120a and the AP MLD 110.

Also, although the links 150a-150c are shown as links between the non-AP MLD 120a and the AP MLD 110, the aspects of this disclosure are not limited to this example. In some aspects, the multi-link communication can be between two AP MLDs. Additionally or alternatively, the multi-link communication can be between two non-AP MLDs. For example, the communication between two non-AP MLDs (and links 150) can be direct communication (and direct links) between these non-AP MLDs. Additionally or alternatively, the communication between two non-AP MLDs (and links 150) is through AP MLD 110. In this example, the wireless communications 140a and 140b, as shown in FIG. 1A, can include links 150a-150c of FIG. 1B.

According to some aspects, and as discussed in more detail below, the non-AP MLD 120a can include two or more radios for communicating with the AP MLD 110 using multiple links 150. According to some aspects, and as discussed in more detail below, the AP MLD 110 and the non-AP MLD 120a can implement the multi-link TWT scheme to save power while maintaining good delay performance through multilink transmissions. For example, as discussed in more detail below, the AP MLD 110 and/or the non-AP MLD 120a can control one or more multi-link service period(s) (SP) and/or can transmit control or information frames on the multi-link SPs to perform the multi-link TWT scheme.

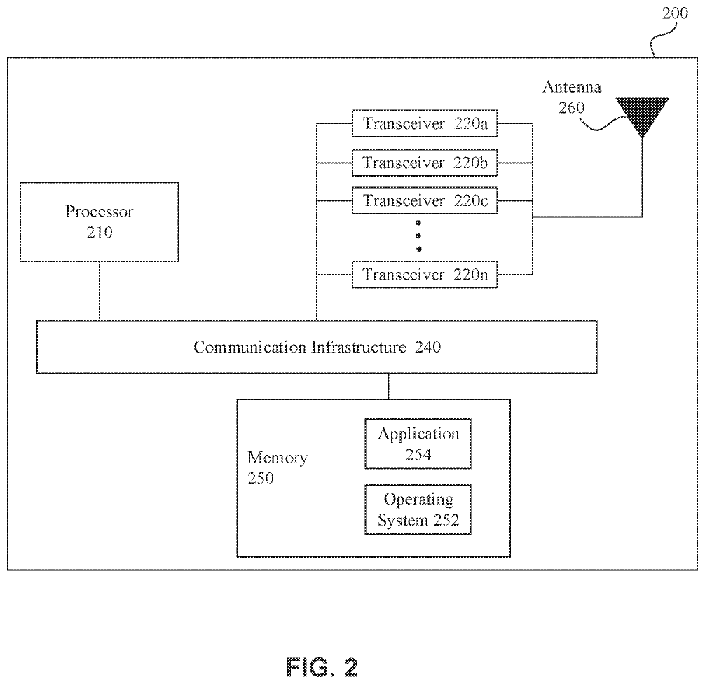

FIG. 2 illustrates a block diagram of an example wireless system 200 of an electronic device implementing the TWT scheme for multi-link communication network, according to some aspects. System 200 may be any of the electronic devices (e.g., AP MILD 110, non-AP MILD 120) of system 100. System 200 includes one or more processors 210, one or more transceivers 220a-220n, a communication infrastructure 240, one or more memories 250, an operating system 252, an application 254, and one or more antennas 260. Illustrated systems are provided as exemplary parts of wireless system 200, and system 200 can include other circuit(s) and subsystem(s). Also, although the systems of wireless system 200 are illustrated as separate components, the aspects of this disclosure can include any combination of these components, less components, or more components.

The memory 250 may include random access memory (RAM) and/or cache, and may include control logic (e.g., computer software) and/or data. The memory 250 may include other storage devices or memory such as, but not limited to, a hard disk drive and/or a removable storage device/unit. According to some examples, the operating system 252 can be stored in the memory 250. The operating system 252 can manage transfer of data from the memory 250 and/or one or more applications 254 to the processor 210 and/or one or more transceivers 220a-220n. In some examples, the operating system 252 maintains one or more network protocol stacks (e.g., Internet protocol stack, cellular protocol stack, and the like) that can include a number of logical layers. At corresponding layers of the protocol stack, the operating system 252 includes control mechanism and data structures to perform the functions associated with that layer.

According to some examples, the application 254 can be stored in the memory 250. Application 254 can include applications (e.g., user applications) used by wireless system 200 and/or a user of wireless system 200. The applications in the application 254 can include applications such as, but not limited to, radio streaming, video streaming, remote control, and/or other user applications.

System 200 can also include the communication infrastructure 240. The communication infrastructure 240 provides communication between, for example, the processor 210, one or more transceivers 220a-220n, and the memory 250. In some implementations, the communication infrastructure 240 may be a bus. The processor 210 together with instructions stored in the memory 250 performs operations enabling wireless system 200 of system 100 to implement the multi-link TWT scheme in the multi-link communication network as described herein. Additionally, or alternatively, one or more transceivers 220a-220n perform operations enabling wireless system 200 of system 100 to implement the multi-link TWT scheme in the multi-link communication network operations as described herein.

One or more transceivers 220a-220n transmit and receive communications signals that support the multi-link TWT scheme, according to some aspects, and may be coupled to the antenna 260. (Herein, transceivers can also be referred to as radios). The antenna 260 may include one or more antennas that may be the same or different types. One or more transceivers 220a-220n allow system 200 to communicate with other devices that may be wired and/or wireless. In some examples, one or more transceivers 220a-220n can include processors, controllers, radios, sockets, plugs, buffers, and like circuits/devices used for connecting to and communication on networks. According to some examples, one or more transceivers 220a-220n include one or more circuits to connect to and communicate on wired and/or wireless networks.

According to some aspects, one or more transceivers 220a-220n can include a cellular subsystem, a WLAN subsystem, and/or a Bluetooth™ subsystem, each including its own radio transceiver and protocol(s) as will be understood by those skilled arts based on the discussion provided herein. In some implementations, one or more transceivers 220a-220n can include more or fewer systems for communicating with other devices.

In some examples, one or more transceivers 220a-220n can include one or more circuits (including a cellular transceiver) for connecting to and communicating on cellular networks. The cellular networks can include, but are not limited to, 3G/4G/5G networks such as Universal Mobile Telecommunications System (UMTS), Long-Term Evolution (LTE), and the like.

Additionally, or alternatively, one or more transceivers 220a-220n can include one or more circuits (including a Bluetooth™ transceiver) to enable connection(s) and communication based on, for example, Bluetooth™ protocol, the Bluetooth™ Low Energy protocol, or the Bluetooth® Low Energy Long Range protocol. For example, transceiver 220n can include a Bluetooth™ transceiver.

Additionally, one or more transceivers 220a-220n can include one or more circuits (including a WLAN transceiver) to enable connection(s) and communication over WLAN networks such as, but not limited to, networks based on standards described in IEEE 802.11 (such as, but not limited to IEEE 802.11ac, IEEE 802.11ax, IEEE 802.11bc, IEEE 802.11bd, IEEE 802.11be, etc.). For example, the transceiver 220a can enable connection(s) and communication over a multi-link WLAN network having a first link (e.g., link 150a) associated with 2.4 GHz wireless communication channel. For example, the transceiver 220b can enable connection(s) and communication over the multi-link WLAN network having a second link (e.g., link 150b) associated with 5 GHz wireless communication channel. For example, the transceiver 220c can enable connection(s) and communication over the multi-link WLAN network having a third link (e.g., link 150c) associated with 6 GHz wireless communication channel. However, the aspects of this disclosure are not limited to these wireless channels and other PHY layer links and/or other wireless channels can be used.

Additionally, or alternatively, wireless system 200 can include one WLAN transceiver configured to operate at two or more links. The processor 210 can be configured to control the one WLAN transceiver to switch between different links, according to some examples. For example, the transceiver 220a can enable connection(s) and communication over a multi-link WLAN network having a first link (e.g., link 150a) associated with 2.4 GHz wireless communication channel. The transceiver 220b can enable connection(s) and communication over the multi-link WLAN network having a second link (e.g., link 150b) associated with 5 GHz wireless communication channel and can enable connection(s) and communication over the multi-link WLAN network having a third link (e.g., link 150c) associated with 6 GHz wireless communication channel. According to some aspects, the switching from the first link to the second link can include using a transceiver (e.g. the, transceiver 220b) associated with the second link instead of the transceiver (e.g., the transceiver 220a) associated with the first link. Additionally, or alternatively, the switching from the first link to the second link can include controlling a single transceiver (e.g., the transceiver 220) to operate at the frequency of the second link instead of operating at the frequency of the first link.

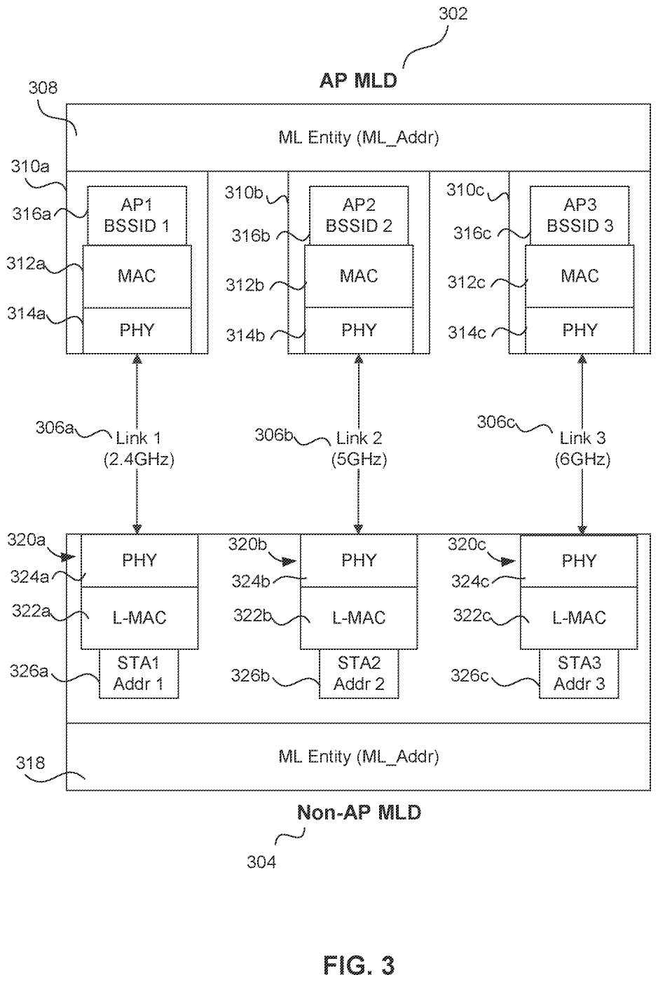

According to some aspects, the processor 210, alone or in combination with computer instructions stored within the memory 250, and/or one or more transceiver 220a-220n, implements the multi-link TWT scheme in the multi-link communication network as discussed herein. As discussed in more detail below with respect to FIGS. 3-13, the processor 210 can implement the multi-link TWT scheme in the multi-link communication network of FIGS. 1A, 1i, and 2.

FIG. 3 illustrates an exemplary communication between AP MILD 302 and non-AP MLD 304 that can be used for the multi-link TWT scheme in the multi-link communication network, according to some aspects. In this example, AP MLD 302 and non-AP MLD 304 can communicate using a multi-link WLAN network having two or more links. For example, AP MLD 302 and non-AP MLD 304 can communicate using links 306a-306c. In some examples, links 306 can be and/or include links 150 of FIG. 1B.

According to some aspects, AP MLD 302 has a multi-link (ML) address 308 associated with non-AP MLD 304. Also, AP MLD 302 can include three radios/transceivers 310a-310c. For example, AP MLD 302 can include transceiver 310a configured to enable connection(s) and communication over a multi-link WLAN network having the first link (e.g., link 306a) associated with 2.4 GHz wireless communication channel. For example, AP MLD 302 can include transceiver 310b configured to enable connection(s) and communication over the multi-link WLAN network having a second link (e.g., link 306b) associated with 5 GHz wireless communication channel. For example, AP MLD 302 can include transceiver 310c configured to enable connection(s) and communication over the multi-link WLAN network having a third link (e.g., link 306c) associated with 6 GHz wireless communication channel. In other words, AP MLD 302 can include three APs operating on a 2.4 GHz channel, on a 5 GHz channel, and on a 6 GHz channel, respectively. However, the aspects of this disclosure are not limited to these wireless channels and other PHY layer links and/or other wireless channels can be used. Also, AP MLD 302 can include less or more radios/transceivers.

According to some examples, each transceiver 310 can include a medium access control (MAC) layer 312 and a physical (PHY) layer 314. In some examples, each transceiver 310 (e.g., each AP) can have an associated basic service set identifiers (BSSID) 316. In these examples, each transceiver 310 (e.g., each AP) can operate independently (e.g., simultaneous transmission (TX) and reception (RX) (STR)) and each transceiver 310 (e.g., each AP) can start at least one BSS, with different BSSIDs. However, the aspects of this disclosure are not limited to these examples and radios/transceivers 310 can include other structures and/or components.

According to some aspects, non-AP MLD 304 has a multi-link (ML) address 318 associated with non-AP MLD 304. Also, non-AP MLD 304 can include three radios/transceivers 320a-320c. For example, non-AP MLD 304 can include transceiver 320a configured to enable connection(s) and communication over a multi-link WLAN network having the first link (e.g., link 306a) associated with 2.4 GHz wireless communication channel. For example, non-AP MLD 304 can include transceiver 320b configured to enable connection(s) and communication over the multi-link WLAN network having a second link (e.g., link 306b) associated with 5 GHz wireless communication channel. Non-AP MLD 304 can include transceiver 320c configured to enable connection(s) and communication over the multi-link WLAN network having a third link (e.g., link 306c) associated with 6 GHz wireless communication channel. However, the aspects of this disclosure are not limited to these wireless channels and other PHY layer links and/or other wireless channels can be used. Also, non-AP MLD 304 can include less or more radios/transceivers. In some implementations, non-AP MLD 304 can include two radios/transceivers 320a-320b, where transceiver 320b can be configured to enable connection(s) and communication over the multi-link WLAN network having the second link (e.g., link 306b) associated with 5 GHz wireless communication channel or over the multi-link WLAN network having the third link (e.g., link 306c) associated with 6 GHz wireless communication channel.

According to some examples, each transceiver 320 can include a lower medium access control (MAC) layer 322 and a physical (PHY) layer 324. Also, each transceiver 320 can have an associated address. However, the aspects of this disclosure are not limited to these examples and radios/transceivers 320 can include other structures and/or components. Each transceiver/radio 320 can also be referred to herein as a station (STA). Additionally, or alternatively, a station (STA) is associated with a specific communication link/channel. For example, a first STA is associated with a first link associated with the 2.4 GHz wireless communication channel. A second STA is associated with a second link associated with the 5 GHz wireless communication channel. And, a third STA is associated with a third link associated with the 6 GHz wireless communication channel.

According to some aspects, when non-AP MLD 304 establishes a multi-link association with AP MLD 302, non-AP MLD 304 may create up to three STAs 326a-326c, each of which associates to one of the APs within AP MLD 302 and each STA 326 has its associated MAC address (different from other STAs). In some examples, non-AP MLD 304 can initially assign the 5/6 GHz transceiver 320b to one of the STAs associated with the 5 GHz and 6 GHz AP, while the other STA 326c does not have an assigned radio, which can be called a virtual STA. The virtual STA can have its own MAC address.

For example, transceiver 320a of STA 326a of non-AP MLD 304 can be associated with and communicate with transceiver 310a (e.g., of one AP) of AP MLD 302 over link 306a associated with a 2.4 GHz wireless communication channel. Transceiver 320b of STA 326b of non-AP MLD 304 can be associated with and communicate with transceiver 310b (e.g., of another AP) of AP MLD 302 over link 306b associated with a 5 GHz wireless communication channel. Transceiver 320c of STA 326c of non-AP MLD 304 can be associated with and communicate with transceiver 310c (e.g., of another AP) of AP MLD 302 over link 306c associated with a 6 GHz wireless communication channel. In some implementations, STA 326c of non-AP MLD 304 can be a virtual STA and non-AP MLD 304 (using, for example, one or more processors) can control transceiver 320b to operate at the frequency of link 306c instead of operating at the frequency of link 306b.

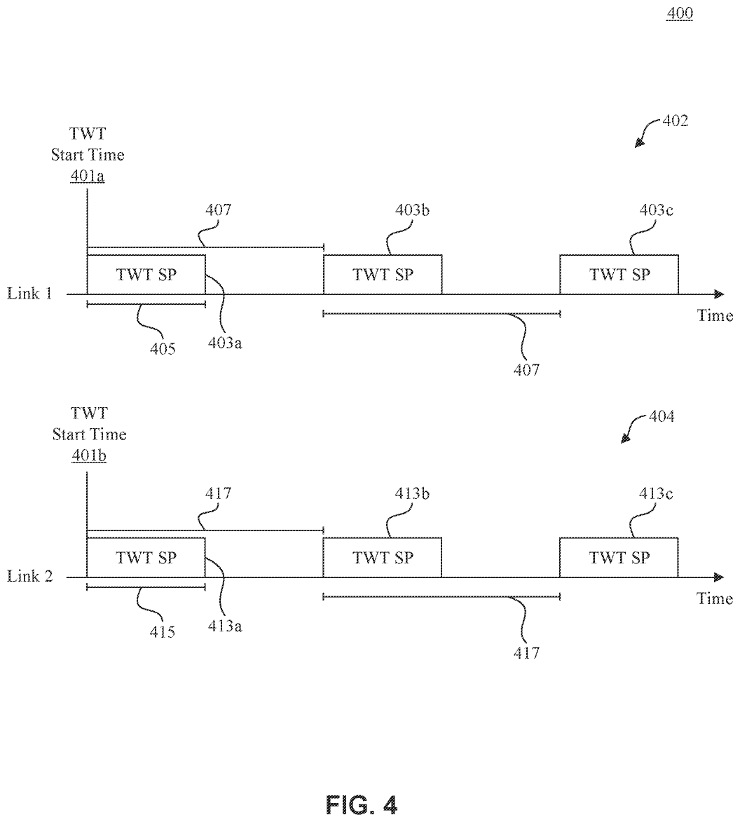

FIG. 4 illustrates an exemplary TWT flow 400, according to some aspects. The TWT flow 400 can be based on the TWT schedule negotiated between an AP MLD and a non-AP MLD. FIG. 4 may be described with regard to elements of FIGS. 1-3.

According to some aspects, the TWT flow 400 can include a TWT flow 402 for a first link (Link 1) and a TWT flow 404 for a second link (Link 2). The first and second links can be the links discussed above with respect to FIGS. 1-3. Although two TWT flows 402 and 404 are illustrated in FIG. 4, the aspects of this disclosure can include any number of TWT flows. Each TWT flow can correspond to one link.

According to some aspects, the TWT flow 402 can include TWT start time 401a that indicates when the TWT scheme starts, e.g., for a first STA of the non-AP MLD 120a. The TWT flow 402 can further include service periods (SPs) 403a, 403b, and 403c. Service periods 403 are the time windows where the first STA of the non-AP MLD 120a will be awake (e.g., in active mode) because the first STA of the non-AP MLD 120a may transmit and/or receive packets during these service periods 403. Service periods 403 can have any duration, such as time duration 405. According to some examples, the service periods 403a, 403b, and 403c have the same time duration 405. Alternatively, two or more of service periods 403a, 403b, and 403c can have different durations. The TWT flow 402 also includes repetition intervals 407. A repetition interval 407 may be the interval between the respective start times of consecutive service periods (e.g., the interval between the start time of the service period 403a and the start time of the service period 403b). When a TWT service period is not ongoing, the first STA of the non-AP MLD 120a can be asleep (e.g., power save mode) or can perform other activities as the first STA of the non-AP MILD 120a does not expect to transmit and/or receive packets associated with this TWT scheme.

According to some aspects, the TWT flow 404 can include TWT start time 401b that indicates when the TWT scheme starts, e.g., for a second STA of the non-AP MLD 120a. The TWT flow 404 can further include service periods (SPs) 413a, 413b, and 413c. Service periods 413 are the time windows where the second STA of the non-AP MLD 120a will be awake (e.g., in active mode) because the second STA of the non-AP MLD 120a may transmit and/or receive packets during these service periods 413. Service periods 413 can have any duration, such as time duration 415. According to some examples, the service periods 413a, 413b, and 413c have the same time duration 415. Alternatively, two or more of service periods 413a, 413b, and 413c can have different durations. The TWT flow 404 also includes repetition intervals 417. A repetition interval 417 may be the interval between the respective start times of consecutive service periods (e.g., the interval between the start time of the service period 413a and the start time of the service period 413b). When a TWT service period is not ongoing, the second STA of the non-AP MLD 120a can be asleep (e.g., power save mode) or can perform other activities as the second STA of the non-AP MLD 120a does not expect to transmit and/or receive packets associated with this TWT scheme.

According to some aspects, the TWT flow 402 of the first link (Link 1) has been configured between a first AP of the AP MLD 302 and a first STA of the non-AP MLD 304 of FIG. 3. Similarly, the TWT flow 404 of the second link (Link 2) has been configured between a second AP of the AP MLD 302 and a second STA of the non-AP MLD 304 of FIG. 3. In some aspects, the TWT flow 402 of the first link has been configured independently from the TWT flow 404 of the second link. Alternatively, the TWT flow 402 of the first link and the TWT flow 404 of the second link are dependent.

According to some aspects, the TWT start time 401a of the TWT flow 402 can be the same or substantially the same (e.g., within ±30 μs or less) as the TWT start time 401b of the TWT flow 404 (e.g., they can be synchronized). Alternatively, the TWT start time 401a of the TWT flow 402 can be different than the TWT start time 401b of the TWT flow 404.

Additionally, according to some aspects, the service periods 403 of the TWT flow 402 can have the same or substantially the same (e.g., within ±30 μs or less) start time, end time, and/or duration as the service periods 413 of the TWT flow 404. Alternatively, one or more of the service periods 403 of the TWT flow 402 can have different start time, end time, and/or duration compared to one or more of the service periods 413 of the TWT flow 404.

According to some aspects, the TWT flow 402 of the first link can be based on a first timing synchronization function (TSF) of the first link and the TWT flow 404 of the second link can be based on a second TSF of the second link. In some examples, TSF corresponds to a clock of, for example, the AP MLD and can be measured in microseconds. In some implementations, the first TSF is different from the second TSF. In these implementations, the difference between the clock running rate of the first TSF and the second TSF can be within a given time duration (such as, but not limited to, ±30 μs.) In some implementations, the first TSF is the same as the second TSF. In some implementations, the second TSF (and other TSFs) can be derived from the first TSF. In some implementations, the TWT flow 402 of the first link and the TWT flow 404 of the second link can be based on one TSF (e.g., the first TSF or the second TSF).

According to some aspects, an information element (IE) and/or a TWT element can be used to set up the multi-link TWT scheme for the multi-link communication network. The IE and/or the TWT element can include (and/or can be used to negotiate) the parameters of the multi-link TWT scheme for the multi-link communication network. For example, the IE and/or the TWT element can include parameters such as, but not limited to, the TWT start time, the TWT SP start time(s), the TWT SP end time(s), the TWT SP duration, the TWT interval, and/or the like.

According to some aspects, the IE and/or the TWT element can be used to set up a TWT scheme for each link of the multi-link communication network separated from other links. In some implementations, the IE and/or the TWT element can include a scoreboard to indicate the link for which the TWT scheme is being set up. Additionally, or alternatively, the IE and/or the TWT element can be used to set up the multi-link TWT scheme for two or more links of the multi-link communication network. In some implementations, the SPs of the multi-link TWT scheme on the two or more links of the multi-link communication network can have the same and/or substantially the same (e.g., within %10 or less) parameters. In these implementations, the AP MILD can set up the multi-link TWT scheme on the two or more links of the multi-link communication network using a single signaling.

In some aspects, the IE and/or the TWT element can include a TWT flow Id and a link ID bitmap (e.g., links to which TWT scheme is being set up. For example, a parameter information field of the IE and/or the TWT parameter information field of the TWT element can include a subfield with a link ID bitmap. According to some aspects, the AP MLD (e.g., the AP MLD 302) can add the TWT flow ID to the IE and/or the TWT element of other links' Beacons. In some implementations, each STA of the non-AP MLD (e.g., the non-AP MLD 304) can determine the link specific parameters by receiving Beacons on the same link (on which the Beacon was received) and/or on other links. The STA can maintain the timing for each link separately by receiving the link specific Beacon. In some implementations, the setup signaling (e.g., the IE and/or the TWT element) may specify link specific parameters for TWT SP.

Some aspects discuss the multi-link TWT scheme with respect to the EMLSR and STR operation modes. However, the aspects of this disclosure can be applied to other operation modes such as, but not limited to, the NSTR operation mode.

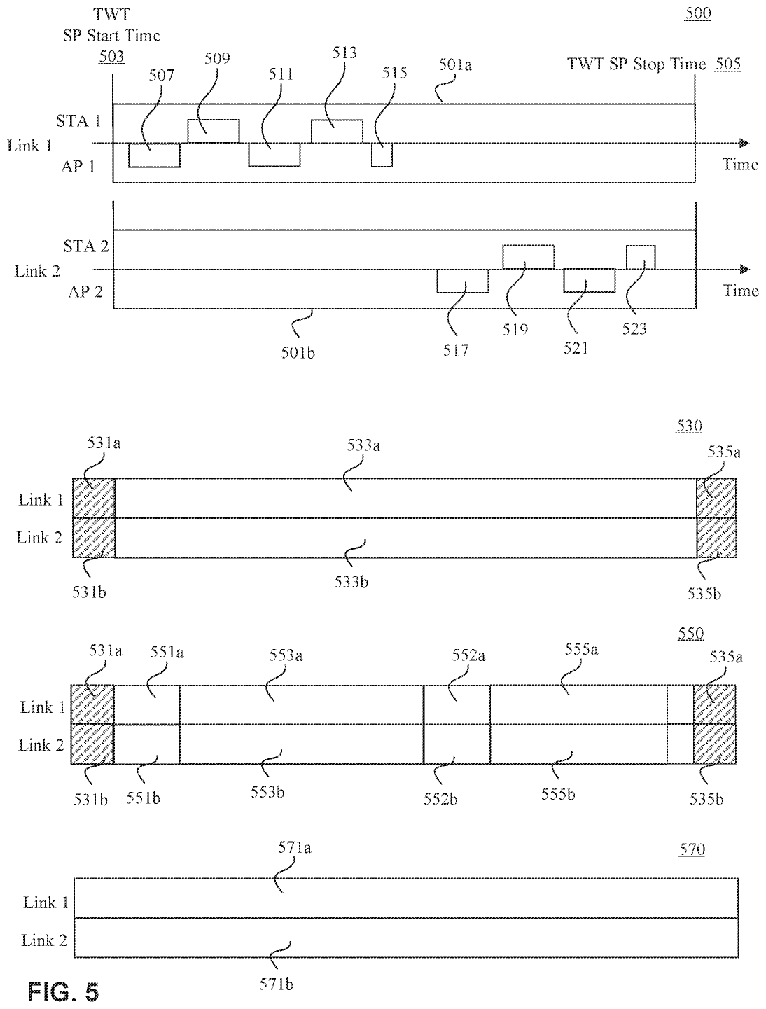

FIG. 5 illustrates an exemplary multi-link TWT flow 500 for two links, according to some aspects. The multi-link TWT flow 500 can be based on the TWT schedule negotiated between an AP MLD and a non-AP MLD. FIG. 5 may be described with regard to elements of FIGS. 1-4. According to some aspects, the multi-link TWT flow 500 can be discussed with respect to the EMLSR operation mode. However, the multi-link TWT flow 500 can also be used for other operations modes.

FIG. 5 illustrates the exemplary multi-link TWT flow 500 that includes two service periods (SPs) 501a and 501b. The SP 501a is associated with a first link (Link 1) and the SP 501b is associated with a second link (Link 2). FIG. 5 further illustrates a configured STA availability 530 on the first and second links. FIG. 5 also illustrates a realized STA availability 550 on the first and second links. Finally, FIG. 5 also illustrates AP availability 570 on the first and second links.

As illustrated in FIG. 5, the SP 501a and the SP 501b can have the TWT SP start time 503 that indicates the start time for both the SP 501a and the SP 501b. In some aspects, the SP 501a can have a different start time than the SP 501b. Additionally, as illustrated in FIG. 5, the SP 501a and the SP 501b can have the TWT SP stop time 505 that indicates the stop time for both the SP 501a and the SP 501b. In some aspects, the SP 501a can have a different stop time than the SP 501b.

According to some aspects, the SP 501a associated with the first link (Link 1) is used for communication between a first STA (STA 1) of a non-AP MLD and a first AP (AP 1) of an AP MLD. Similarly, the SP 501b associated with the second link (Link 2) is used for communication between a second STA (STA 2) of the non-AP MLD and a second AP (AP 2) of the AP MLD. In some examples, the first and second STAs are EMLSR STAs. In some examples, the first and second STAs have a Power Management (PM) that has a first value (e.g., a value of “1”). In some examples, SP 501a and SP 501b are announced TWT SPs.

According to some aspects, and as illustrated by the configured STA availability 530, the first STA is configured to be available 533a during the SP 501a. The first STA is not available 531a before the SP start time 503 and is not available 535a after the SP stop time 505. In some aspects, the first STA can go to power save mode (e.g., sleep mode) during the unavailability periods 531a and 535a. Also, the second STA can go to power save mode (e.g., sleep mode) during the unavailability periods 531b and 535b. Similarly, according to some aspects, and as illustrated by the configured STA availability 530, the second STA is configured to be available 533b during the SP 501b. The second STA is not available 531b before the SP start time 503 and is not available 535b after the SP stop time 505.

According to some aspects, AP availability 570 on the first and second links illustrates that the first AP is available 571a during the TWT scheme and the second AP is also available 571b during the TWT scheme.

According to some aspects, the realized STA availability 550 on the first and second links is associated with the TWT flow 500 and can be different from the configured STA availability 530 depending on the transmissions during the SP 501a and the SP 501b.

According to some aspects, as illustrated in the realized STA availability 550, the first STA is not available during time period 531a before the SP start time 503 and is not available during time period 535a after the SP stop time 505. Similarly, the second STA is not available during time period 531b before the SP start time 503 and is not available during time period 535b after the SP stop time 505.

According to some aspects, during the time periods 551a and 552a, the first AP can send (and the first STA can receive) an initial control frame (ICF) frame. Similarly, during the time periods 551b and 552b, the second AP can send (and the second STA can receive) an ICF frame. In some implementations, the time periods 551a and 552a of the first link can have the same (or substantially the same (e.g., within ±30 μs or less)) start time and stop time as the time periods 551b and 552b of the second link. Alternatively, the time periods 551a and 552a of the first link can have different start time and/or stop time as the time periods 551b and 552b of the second link. According to some aspects, the ICF frame can include a buffer status report poll (BSRP) trigger frame. Additionally, or alternatively, the ICF frame can include a multi-user request to send (MU-RTS) frame. According to some aspects, using the ICF frames transmitted by the APs allows the APs to send downlink (DL) data to the STAs after the STAs have indicated that the STAs are available.

As a non-limiting example, and as discussed with respect to the realized STA availability 550 and the TWT flow 500, the first AP (e.g., AP 1 of an AP MLD) can send a BSRP trigger frame 507 to the first STA (e.g., STA 1 of a non-AP MLD) on the first link (Link 1). In response, the first STA can send a buffer status report (BSR) frame 509 on the first link to the first AP. In response, the first AP can send a trigger frame 511 to trigger the first STA to send its data. For example, in response to the trigger frame 511, the first STA transmits data 513 to the first AP on the first link. In response to the data 513, the first AP can send an acknowledgment (e.g., a block acknowledgment (BA)) 515 to the first STA. During this communication between the first STA and the first AP on the first link, the second STA (e.g., STA 2 of the non-AP MLD) on the second link can be unavailable (e.g., be in the power save mode) or can use a low power receive radio. In other words, during this communication between the first STA and the first AP on the first link, the non-AP MLD can transition its second STA on the second link from available to unavailable (e.g., be in the power save mode) or to use a low power receive radio.

Corresponding to the communication between the first STA and the first AP on the first link and as illustrated in the realized STA availability 550, the first STA receives the ICF frame (e.g., the BSRP frame 507) during time period 551a and the first STA is available (e.g., has an available radio) during time period 553a. However, the second STA is unavailable (e.g., has its radio in the power save mode) or can use a low power receive radio during time period 553b. Time period 553a is a portion of SP 501a and time period 553b is a portion of SP 501b.

After the first STA communicates with the first AP on the first link, the non-AP MILD (that has the first and second STAs) can use a delay time before another communication starts on the same or on other links. In a non-limiting example, the delay can be around 100 μs. However, other values can be used for the delay.

Continuing with the realized STA availability 550 and the TWT flow 500, after the delay after the communication on the first link, the second AP (e.g., AP 2 of the AP MLD) can send a MU-RTS frame 517 to the second STA (e.g., STA 2 of the non-AP MLD) on the second link (Link 2). In response, the second STA can send a clear to send (CTS) frame 519 on the second link to the second AP. In response, the second AP can send data 521 to the second STA on the second link. In response to the data 521, the second STA can send an acknowledgment (e.g., a block acknowledgment (BA)) 523 to the second AP. During this communication between the second STA and the second AP on the second link, the first STA on the first link can be unavailable (e.g., be in the power save mode) or can use a low power receive radio.

Corresponding to the communication between the second STA and the second AP on the second link and as illustrated in the realized STA availability 550, the second STA receives the ICF frame (e.g., the MU-RTS frame 517) during time period 552b and the second STA is available (e.g., has an available radio) during time period 555b. However, the first STA is unavailable (e.g., has its radio in the power save mode) or can use a low power receive radio during time period 555a. In other words, during this communication between the second STA and the second AP on the second link, the non-AP MLD can transition its first STA on the first link from available to unavailable (e.g., be in the power save mode) or to use a low power receive radio. Time period 555a is a portion of SP 501a and time period 555b is a portion of SP 501b.

According to some aspects, a non-AP MLD (or a STA of the non-AP MLD) that has setup the multi-link TWT scheme can control the number of links in which a TWT SP is started. In some implementations, that the non-AP MILD (or the STA of the non-AP MILD) can start the TWT SP in all links. For example, FIG. 5 discussed above provides one example where the non-AP MLD (or the STA of the non-AP MLD) can start the SPs 501a and 501b on the first link and the second link, respectively. In some examples, the non-AP MLD transmits on one link at a time.

According to some aspects, the multi-link TWT scheme discussed herein can be used with the announced TWT SP, the unannounced TWT SP, the triggered TWT SP, or a combination therefore. In some implementations that use the announced TWT SP, the AP MLD (or one or more APs of the AP MLD) can receive an indication from the non-AP MLD (or corresponding STA of the non-AP MLD) that the non-AP MLD (or the STA) is available before the AP MLD (or the corresponding AP) sends data to the non-AP MLD (or the STA). In some examples, the announced TWT SP can be used with EMLSR STAs. The EMLSR STAs can send a frame before they may send their data. The announced TWT SP can also be used with STR STAs. When using the STR STA, each link may operate separately and links may be taken into use when the links become available. The announced TWT SP can also be used with NSTR STAs. When using the NSTR STA, the fastest link can transmit and the other links will likely not be operated. In some examples, the announced TWT SP can allow a STA to skip a whole TWT SP, if the STA does not send UL data to the AP.

According to some aspects, the STA availability in the announced TWT SP can include different operation modes. For example, in a first operation mode, the STA may not be available for the TWT SP. In a second operation mode, the STA may be available for an initial frame (e.g., the ICF frame) (e.g., AP expectation during the TWT SP duration). In this exemplary operation mode, the AP may not send DL data. The initial control frame is different from the DL data. In a third operation mode, the STA may be available for DL data (e.g., the AP expectation after SP initial frame is transmitted). In this exemplary operation mode, the AP may send DL data. The realized STA availability discussed herein can include one or more of the first, second, and third operation modes discussed above.

In some aspects, an EMLSR transmit opportunity (TXOP) initiated by the AP requires the initial control frame transmission. According to some aspects, in multi-link TWT using the EMLSR operation mode, the successful transmission of a TWT SP initial frame (e.g., the ICF frame) can make the non-AP MLD (or the STAs of the non-AP MLD) available for DL data in all EMLSR links of the TWT SP. This can signal to the AP MILD (or corresponding APs of the AP MILD) that all links move to the third operation mode (discussed above) immediately.

According to some aspects, in the STR operation mode, every link needs to be moved separately to the third operation mode discussed above. In other words, in multi-link TWT using the STR operation mode, the successful transmission of a TWT SP initial frame (e.g., the ICF frame) on one STR link can make the STA corresponding to that link available for DL data. In this example, other STAs on other links may not be available for the DL data. This can signal to the corresponding AP that the one STR link moves to the third operation mode (discussed above) immediately.

In some aspects, the realized STA availability used herein can include the first, second, and/or third operation modes discussed above.

According to some aspects, if a STA is operating in the second operation mode discussed above (e.g., the initial frame transmission availability) and the AP has not transmitted an initial frame (e.g., the ICF frame) for a long time (e.g., a time greater than a threshold), the AP may consider that STA may not be available in the TWT SP, because there may not be enough time to transmit data packets/frames during the TWT SP.

According to some aspects, if a STA is operating in the second operation mode discussed above (e.g., the initial frame transmission availability), the AP may transmit or retransmit less number of times the initial frame (e.g., the ICF frame). For example, the AP may transmit a first initial frame in a TWT SP. If the AP does not receive a response to the initial frame from the STA, the AP may decide not to retransmit the initial frame during that TWT SP to that STA. Alternatively, if the AP does not receive the response to the initial frame from the STA, the AP may decide to retransmit the initial frame less number of times (e.g., transmit less number of initial frames) during that TWT SP.

According to some aspects, the STA operating in the second operation mode discussed above may skip operation in the TWT SP. For example, the STA may know that the AP will not send any DL data to the STA. Therefore, the STA may skip operation in the TWT SP (e.g., the STA will not be available for the TWT SP) because the STA knows that it will not lose any DL data.

According to some aspects, the non-AP MLD (or the STA of the non-AP MLD) can send a frame (such as, but not limited to, a quality of service (QoS) Null frame) to signal that one STA of the non-AP MLD will not be available for multi-link TWT on the STA's corresponding link.

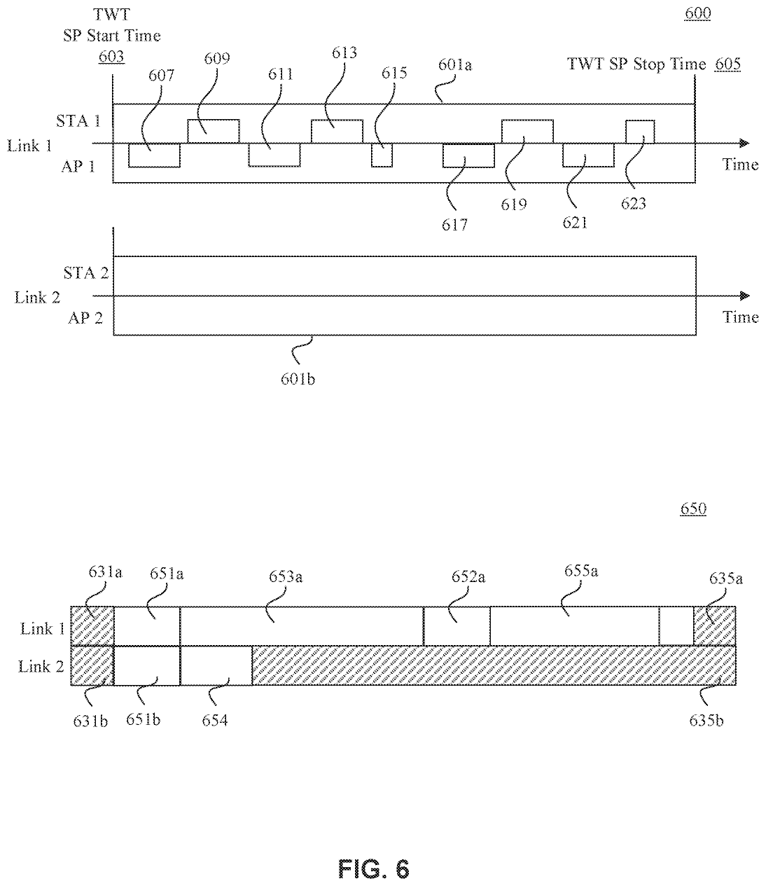

FIG. 6 illustrates an exemplary multi-link TWT flow 600 for two links with service period canceling, according to some aspects. The multi-link TWT flow 600 can be based on the TWT schedule negotiated between an AP MLD and a non-AP MLD. FIG. 6 may be described with regard to elements of FIGS. 1-5. According to some aspects, the multi-link TWT flow 600 can be discussed with respect to the EMLSR operation mode. However, the multi-link TWT flow 600 can also be used for other operations modes.

FIG. 6 illustrates the exemplary multi-link TWT flow 600 that includes two service periods (SPs) 601a and 601b. The SP 601a is associated with a first link (Link 1) and the SP 601b is associated with a second link (Link 2). FIG. 6 also illustrates a realized STA availability 650 on the first and second links.

As illustrated in FIG. 6, the SP 601a and the SP 601b can have the TWT SP start time 603 that indicates the start time for both the SP 601a and the SP 601b. In some aspects, the SP 601a can have a different start time than the SP 601b. Additionally, as illustrated in FIG. 6, the SP 601a and the SP 601b can have the TWT SP stop time 605 that indicates the stop time for both the SP 601a and the SP 601b. In some aspects, the SP 601a can have a different stop time than the SP 601b.

According to some aspects, the SP 601a associated with the first link (Link 1) is used for communication between a first STA (STA 1) of a non-AP MLD and a first AP (AP 1) of an AP MLD. Similarly, the SP 601b associated with the second link (Link 2) is used for communication between a second STA (STA 2) of the non-AP MLD and a second AP (AP 2) of the AP MLD. In some examples, the first and second STAs are EMLSR STAs. In some examples, the first and second STAs have a PM that has a first value (e.g., a value of “1”). In some examples, SP 601a and SP 601b are announced TWT SPs.

According to some aspects, as illustrated in the realized STA availability 650, the first STA is not available during time period 631a before the SP start time 603 and is not available during time period 635a after the SP stop time 605. Similarly, the second STA is not available during time period 631b before the SP start time 603 and is not available after the SP stop time 605.

According to some aspects, during the time periods 651a and 652a, the first AP can send (and the first STA can receive) an initial control frame (ICF) frame. Similarly, during the time periods 651b, the second AP can send (and the second STA can receive) an ICF frame. In some implementations, the time periods 651a and 652a of the first link can have the same (or substantially the same (e.g., within ±30 μs or less)) start time and stop time as the time period 651b of the second link. Alternatively, the time periods 651a and 652a of the first link can have different start time and/or stop time as the time periods 651b of the second link.

As a non-limiting example, and as discussed with respect to the realized STA availability 650 and the TWT flow 600, the first AP (e.g., AP 1 of an AP MLD) can send a BSRP trigger frame 607 to the first STA (e.g., STA 1 of a non-AP MLD) on the first link (Link 1). In response, the first STA can send a BSR frame 609 on the first link to the first AP. In response, the first AP can send a trigger frame 611 to trigger the first STA to send its data. For example, in response to the trigger frame 611, the first STA transmits data 613 to the first AP on the first link. In response to the data 613, the first AP can send an acknowledgment (e.g., a block acknowledgment (BA)) 615 to the first STA. Corresponding to the communication between the first STA and the first AP on the first link and as illustrated in the realized STA availability 650, the first STA receives the ICF frame (e.g., the BSR frame 609) during time period 651a and the first STA is available (e.g., has an available radio) during time period 653a.

According to some aspects, BSR frame 609 can include a frame (such as, but not limited to, a QoS Null frame) to signal that the second STA (STA 2 of the non-AP MLD) on the second link (Link 2) is unavailable (e.g., has its radio in the power save mode). During the time period 654 (which can include the duration of BSR frame 609), the second STA on the second link can be unavailable (e.g., be in the power save mode) or can use a low power receive radio. However, during the time period 635b (e.g., after sending the QoS Null frame within or with the BSR frame 609), the second STA on the second link will be unavailable (e.g., be in the power save mode). In this example, during the time period 635b the second AP (AP 2) will not transmit frames to the second STA on the second link during the SP 601b.

After the first STA communicates with the first AP on the first link, the non-AP MLD (that has the first and second STAs) can use a delay time before another communication starts on the same link. In a non-limiting example, the delay can be around 100 μs. However, other values can be used for the delay.

Continuing with the realized STA availability 650 and the TWT flow 600, after the delay after the communication on the first link, the first AP (AP 1) can send a MU-RTS frame 617 to the first STA (STA 1) on the first link (Link 1). In response, the first STA can send a CTS frame 619 on the first link to the first AP. In response, the first AP can send data 621 to the first STA on the first link. In response to the data 621, the first STA can send an acknowledgment (e.g., a block acknowledgment (BA)) 623 to the first AP. During this communication between the first STA and the first AP on the first link, the second STA on the second link is unavailable (e.g., be in the power save mode). Corresponding to the communication between the first STA and the first AP on the first link and as illustrated in the realized STA availability 650, the first STA receives the ICF frame (e.g., the MU-RTS frame 617) during time period 652a and the first STA is available (e.g., has an available radio) during time period 655a. Time periods 653a and 655a are portions of SP 601a and time period 654 is a portion of SP 601b.

According to some aspects, the BSRP trigger frame 607 can solicit the BSR frame 609. The BSR frame 609 can include a frame (such as, but not limited to, the QoS Null frame) to signal that one STA (e.g., the second STA) of the non-AP MLD will not be available for multi-link TWT on the STA's corresponding link (e.g., the second link). In some implementations, A-Control field in the QoS-Null frames can be used to signal the unavailability of the STA of the STA's corresponding link.

In some implementations, a Retry bit or a More Fragments bit of a Frame Control field of a MAC header of the QoS Null can be used to signal the unavailability of the other STAs on their corresponding links. For example, the Retry bit or the More Fragments bit may be set to a first value (e.g., a value of “1”) to indicate the unavailability of the other STAs on their corresponding link. The Retry bit or the More Fragments bit may be set to a second value (e.g., value “0”) to indicate the availability of the other STAs on their corresponding links. For example, the Retry bit or the More Fragments bit associated with BSR frame 609 may be set to the first value (e.g., the value of “1”) to indicate the unavailability of the second STA on the second link.

In some implementations, the Retry bit or the More Fragments bit may be set to a first value (e.g., a value of “1”) to indicate that a service period is not started in other links. Otherwise, the Retry bit or the More Fragments bit may be set to a second value (e.g., a value of “0”). For example, the Retry bit or the More Fragments bit associated with BSR frame 609 may be set to the first value (e.g., the value of “1”) to indicate that the SP 601b ends after time period 654.

Additionally, or alternatively, the non-AP MLD (or the STA of the non-AP MLD) can send a frame (such as, but not limited to, a TWT information frame) to signal and control the availability of the non-AP MLD (or one or more STAs of the non-AP MLD) on the links of the multi-link TWT.

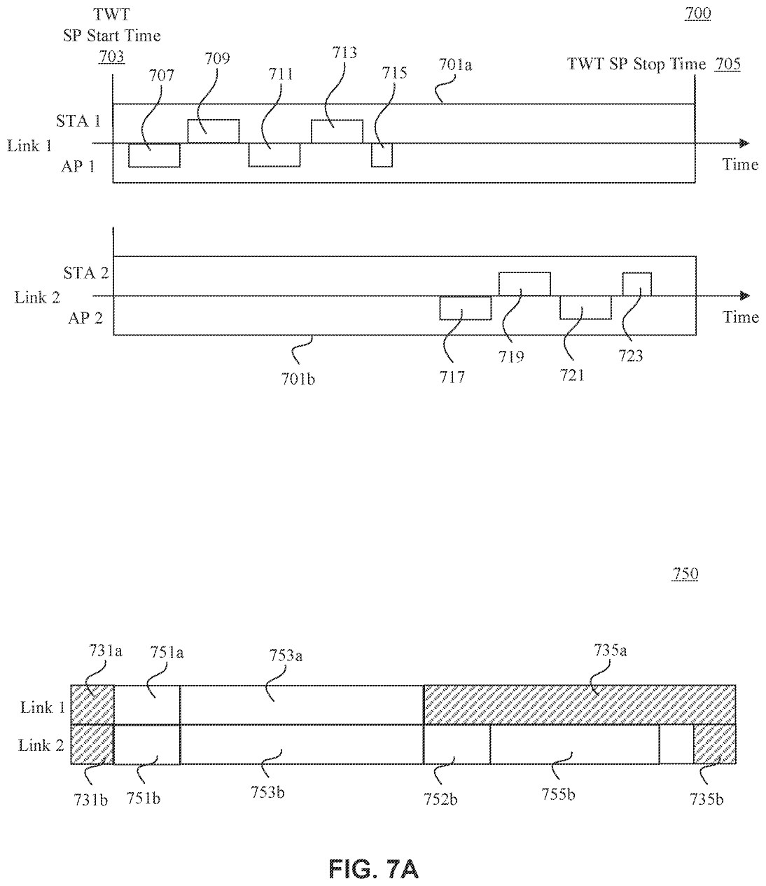

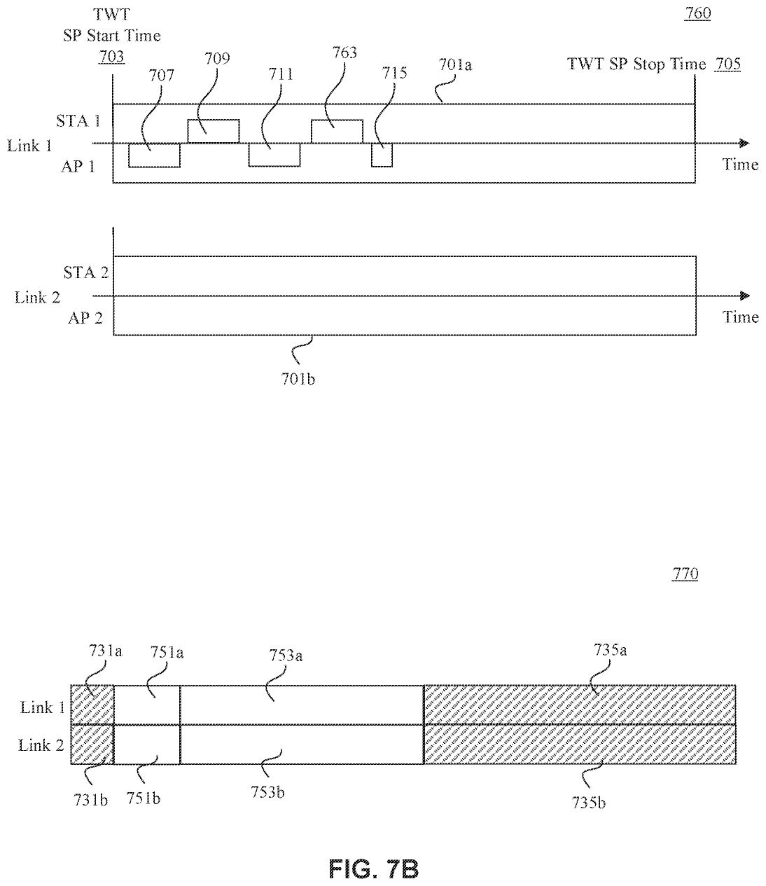

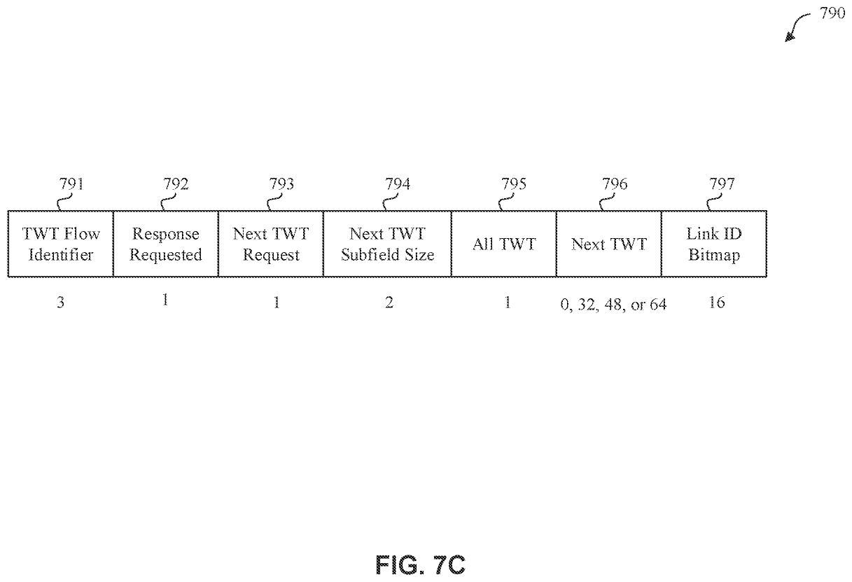

FIGS. 7A-7C illustrate exemplary multi-link TWT flows and TWT information frame for controlling the availability of STAs on the links of the multi-link TWT, according to some aspects. The multi-link TWT flows 700 and 760 can be based on the TWT schedule negotiated between an AP MLD and a non-AP MLD. FIGS. 7A-7C may be described with regard to elements of FIGS. 1-6. According to some aspects, the multi-link TWT flows 700 and 760 can be discussed with respect to the EMLSR operation mode. However, the multi-link TWT flows 700 and 760 can also be used for other operations modes.

FIG. 7A illustrates the exemplary multi-link TWT flow 700 that includes two service periods (SPs) 701a and 701b. The SP 701a is associated with a first link (Link 1) and the SP 701b is associated with a second link (Link 2). FIG. 7A also illustrates a realized STA availability 750 on the first and second links.

As illustrated in FIG. 7A, the SP 701a and the SP 701b can have the TWT SP start time 703 that indicates the start time for both the SP 701a and the SP 701b. In some aspects, the SP 701a can have a different start time than the SP 701b. Additionally, as illustrated in FIG. 7A, the SP 701a and the SP 701b can have the TWT SP stop time 705 that indicates the stop time for both the SP 701a and the SP 701b. In some aspects, the SP 701a can have a different stop time than the SP 701b.

According to some aspects, the SP 701a associated with the first link (Link 1) is used for communication between a first STA (STA 1) of a non-AP MLD and a first AP (AP 1) of an AP MLD. Similarly, the SP 701b associated with the second link (Link 2) is used for communication between a second STA (STA 2) of the non-AP MLD and a second AP (AP 2) of the AP MLD. In some examples, the first and second STAs are EMLSR STAs. In some examples, the first and second STAs have a PM that has a first value (e.g., a value of “1”). In some examples, SP 701a and SP 701b are announced TWT SPs.

According to some aspects, as illustrated in the realized STA availability 750, the first STA is not available during time period 731a before the SP start time 703 and is not available after the SP stop time 705. Similarly, the second STA is not available during time period 731b before the SP start time 703 and is not available during time period 735b after the SP stop time 705.

According to some aspects, during the time period 751a, the first AP can send (and the first STA can receive) an ICF frame. Similarly, during the time periods 751b and 752b, the second AP can send (and the second STA can receive) an ICF frame. In some implementations, the time period 751a of the first link can have the same (or substantially the same (e.g., within ±30 μs or less)) start time and stop time as the time periods 751b and 752b of the second link. Alternatively, the time period 751a of the first link can have different start time and/or stop time as the time periods 751b and 752b of the second link.

As a non-limiting example, and as discussed with respect to the realized STA availability 750 and the TWT flow 700, the first AP (e.g., AP 1 of an AP MLD) can send a BSRP trigger frame 707 to the first STA (e.g., STA 1 of a non-AP MLD) on the first link (Link 1). In response, the first STA can send a BSR frame 709 on the first link to the first AP. In response, the first AP can send a trigger frame 711 to trigger the first STA to send its data. For example, in response to the trigger frame 711, the first STA transmits the data frame 713 to the first AP on the first link. In response to the data frame 713, the first AP can send an acknowledgment (e.g., a block acknowledgment (BA)) 715 to the first STA. Corresponding to the communication between the first STA and the first AP on the first link and as illustrated in the realized STA availability 750, the first STA receives the ICF frame (e.g., the BSR frame 709) during time period 751a and the first STA is available (e.g., has an available radio) during time period 753a. During the time period 753b, the second STA on the second link can be unavailable (e.g., be in the power save mode) or can use a low power receive radio. In other words, during time period 753b, the non-AP MLD can transition its second STA on the second link from available to unavailable (e.g., be in the power save mode) or to use a low power receive radio.

According to some aspects, the data frame 713 can include a frame (such as, but not limited to, a TWT information frame) to indicate the availability of the first STA on the first link or the availability of the second STA on the second link. In some implementations, the data frame can be aggregated with the TWT information frame. Additionally, or alternatively, the first STA can send the TWT information frame at any time during the SP 701a.

According to some aspects, the TWT information frame associated with the data frame 713 can indicate that the first STA will be unavailable (e.g., has its radio in the power save mode) on the first link for the rest of the duration of SP 701a (e.g., the time period 735a). In other words, the STA (e.g., the first STA) signals that it will be unavailable on the link (e.g., the first link) that the STA transmitted the data frame 713 and the TWT information frame. Additionally, or alternatively, the first STA can signal that the second STA will be unavailable on the second link but the first STA would continue to be available on the first link.

After the first STA communicates with the first AP on the first link, the non-AP MLD (that has the first and second STAs) can use a delay time before another communication starts on the second link. In a non-limiting example, the delay can be around 100 μs. However, other values can be used for the delay.

Continuing with the realized STA availability 750 and the TWT flow 700, after the delay after the communication on the first link, the second AP (AP 2) can send a MU-RTS frame 717 to the second STA (STA 1) on the second link (Link 2). In response, the second STA can send a CTS frame 719 on the second link to the second AP. In response, the second AP can send data 721 to the second STA on the second link. In response to the data 721, the second STA can send an acknowledgment (e.g., a block acknowledgment (BA)) 723 to the second AP. During this communication between the second STA and the second AP on the second link, the first STA on the first link is unavailable (e.g., be in the power save mode). Corresponding to the communication between the second STA and the second AP on the second link and as illustrated in the realized STA availability 750, the second STA receives the ICF frame (e.g., the MU-RTS frame 717) during time period 752b and the second STA is available (e.g., has an available radio) during time period 755b. Time periods 753a and 735a are portions of SP 701a and time periods 753b and 755b are portions of SP 701b.

FIG. 7B illustrates the exemplary multi-link TWT flow 760 that includes two service periods (SPs) 701a and 701b. The SP 701a is associated with a first link (Link 1) and the SP 701b is associated with a second link (Link 2). The SPs 701a and 701b are the same as SPs 701a and 701b of FIG. 7A. FIG. 7B also illustrates a realized STA availability 770 on the first and second links.

According to some aspects, as illustrated in the realized STA availability 770, the first STA is not available during time period 731a before the SP start time 703 and is not available after the SP stop time 705. Similarly, the second STA is not available during time period 731b before the SP start time 703 and is not available after the SP stop time 705.

According to some aspects, during the time period 751a, the first AP can send (and the first STA can receive) an ICF frame. Similarly, during the time period 751b, the second AP can send (and the second STA can receive) an ICF frame.

As a non-limiting example, and as discussed with respect to the realized STA availability 770 and the TWT flow 760, the first AP (e.g., AP 1 of an AP MLD) can send a BSRP trigger frame 707 to the first STA (e.g., STA 1 of a non-AP MLD) on the first link (Link 1). In response, the first STA can send a BSR frame 709 on the first link to the first AP. In response, the first AP can send a trigger frame 711 to trigger the first STA to send its data. For example, in response to the trigger frame 711, the first STA transmits the data frame 763 to the first AP on the first link. In response to the data frame 763, the first AP can send an acknowledgment (e.g., a block acknowledgment (BA)) 715 to the first STA.

According to some aspects, the data frame 763 can include a frame (such as, but not limited to, a TWT information frame) to indicate the availability of the first STA on the first link and the availability of the second STA on the second link. In some implementations, the data frame can be aggregated with the TWT information frame. Additionally, or alternatively, the first STA can send the TWT information frame at any time during the SP 701a.

According to some aspects, the TWT information frame associated with the data frame 763 can indicate that the first STA will be unavailable (e.g., has its radio in the power save mode) on the first link for the rest of the duration of SP 701a (e.g., the time period 735a) and can indicate that the second STA will be unavailable (e.g., has its radio in the power save mode) on the second link for the rest of the duration of SP 701b (e.g., the time period 735b). In this example, after the first AP sends the BA 715, no communication occurs between the AP MLD and the non-AP MLD during the SPs 701a and 701b.

The TWT information frame can be sent over any link of the multiple links of the multi-link TWT scheme. The TWT information frame can indicate the availability of any STA on the STA's corresponding link. Similarly, the TWT information frame can terminate any ongoing SP in a link on which the TWT information frame was transmitted. Time periods 753a and 735a are portions of SP 701a and time periods 753b and 735b are portions of SP 701b.

FIG. 7C illustrates a TWT information field 790, according to some aspects. The TWT information field 790 can be part of the TWT information frame. The TWT information frame can include a category field and the TWT information field 790. The TWT information frame can include other fields. The TWT information field 790 can include a TWT flow identifier subfield 791, a response requested subfield 792, a next TWT request subfield 793, a next TWT subfield size subfield 794, an all TWT subfield 795, a next TWT subfield 797, and a link identifier (ID) bitmap subfield 797. The numbers under each subfield of TWT information field 790 represent an exemplary size of the respective subfield of the TWT information field 790 in bits. In other implementations, other sizes can be used. The TWT information field 790 can be used to indicate and control the availability of STAs on their corresponding links.

According to some aspects, the TWT Information frame can include multiple TWT information fields 790. For example, if the non-AP MILD (or the non-AP MLD's STA) combine signaling for multiple TWT flows, the TWT Information frame can include multiple TWT information fields 790.

Similarly, the AP MILD (or the AP MLD's APs) can send one or more TWT information frames to the non-AP MLD (or the non-AP MLD's STAs), where the TWT information frame can include the TWT information field 790 including the link ID bitmap subfield 797. For example, the AP may send the TWT information frame to the STA, if the AP will not be able to transmit to the STA on other links, or if the AP is to suspend TWT flows on specific links.

According to some aspects, a bit N in the link ID bitmap subfield 797 can be set to a first value (e.g., a value of “1”) to signal that a STA associated with the link associated with bit N is unavailable. Otherwise the bit N can be set to a second value (e.g., a value of “0”).

In addition to, or alternatively to, using the link ID bitmap subfield 797 to signal the availability of STA(s) on corresponding link(s), the link ID bitmap subfield 797 can also be used to suspend and/or resume TWT flows on different links. According to some aspects, a bit N in the link ID bitmap subfield 797 can be set to a first value (e.g., a value of “1”) to signal that the TWT information frame suspends, or resumes, a specific TWT flow on the link associated with bit N. Otherwise the bit N is set to a second value (e.g., a value of “0”). In some implementations, if the TWT information frame does not contain link ID bitmap subfield 797, then all links that contain the TWT flow identified by the TWT flow identifier subfield 791 can be suspended/resumed.

According to some aspects, if all TWT subfield 795 is set to a first value (e.g., a value of “1”), then all TWT flows on the links identified by link ID bitmap subfield 797 are suspended/resumed. The TWT flows on other links continue to operate normally.

Although some examples are discussed with respect to the TWT information frame and the link ID bitmap subfield, the aspects of this disclosure can used other frames and/or fields to indicate the availability of STAs (and/or APs) on different links of the multi-link TWT scheme.

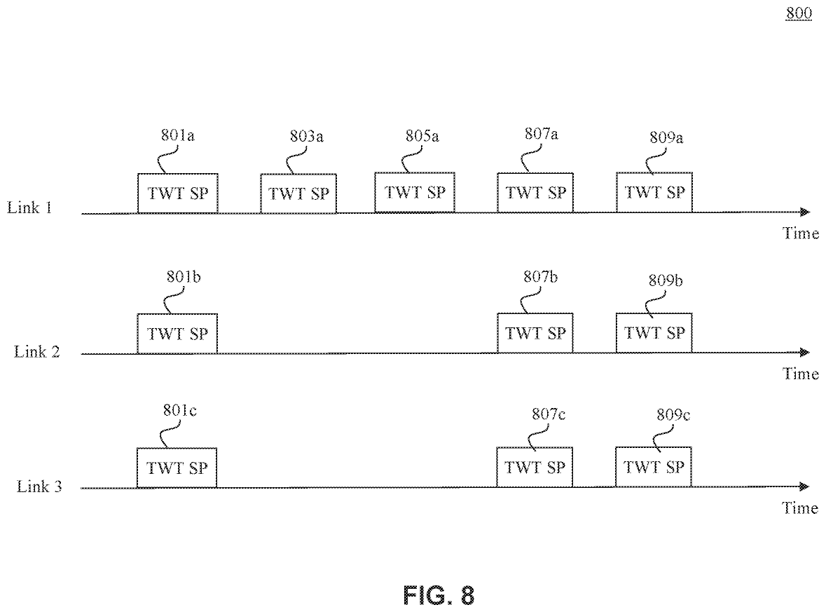

FIG. 8 illustrates an exemplary multi-link TWT flow 800 for suspending and/or resuming link specific TWT flows, according to some aspects. The multi-link TWT flow 800 can be based on the TWT schedule negotiated between an AP MLD and a non-AP MLD. FIG. 8 may be described with regard to elements of FIGS. 1-7. According to some aspects, the multi-link TWT flow 800 can be discussed with respect to the EMLSR operation mode. However, the multi-link TWT flow 800 can also be used for other operations modes

As illustrated in FIG. 800, the multi-link TWT flow 800 can include a first TWT flow associated with a first link (Link 1), a second TWT flow associated with a second link (Link 2), and a third TWT flow associated with a third link (Link 3). The first TWT flow can include the TWT SPs 801a-809a. In some aspects, a frame (such as, but not limited to, a TWT information frame) can be transmitted during the TWT SP 801a that can suspend the TWT SPs on the second link and the third link. For example, the TWT information frame can be transmitted during the TWT SP 801a that can suspend the TWT SPs after TWT SP 801b on the second link. Similarly, the TWT information frame transmitted during the TWT SP 801a can suspend the TWT SPs after TWT SP 801c on the third link.

Additionally, or alternatively, the TWT information frame can be transmitted during the TWT SP 805a that can resume the TWT SPs on the second link and the third link. For example, the TWT information frame can be transmitted during the TWT SP 805a that can resume the TWT SPs 807b and 809b on the second link. Similarly, the TWT information frame transmitted during the TWT SP 807a can resume the TWT SPs 807c and 809c on the third link.

As discussed above, in some implementations, the TWT information frame can signal whether the STA or the AP are available on the upcoming TWT SPs. Additionally, or alternatively, the TWT information frame can signal whether the TWT SPs are suspended or are resumed.

In some implementations, the transmitter of the TWT information frame may signal that it suspends the TWT SP for a period of time, or until further notice. The TWT information frame may be transmitted to signal that the STA (or the AP) resumes to the TWT SPs earlier, or it may provide the TWT SP in which the STA resumes. According to some aspects, the TWT SPs in a link, a set of links, or on all links may be suspended for a period of time.

According to some aspects, the TWT SPs on multiple links of the multi-link TWT scheme can have the same (or substantially the same (e.g., within ±30 μs or less)) start times. In some aspects, the AP MLD can send ICF frames on multiple links of the multi-link TWT scheme. For example, and assuming two links for the multi-link TWT scheme, the first AP can send a first ICF frame on the first link to the first STA and the second AP can send a second ICF frame on the second link to the second STA. In some implementations, the first and second ICF frames can be sent synchronously (e.g., at the same time or substantially the same time (e.g., within ±30 μs or less)). In some implementations, the first and second ICF frames are sent with some delay with respect to each other. If the first and second ICF frames are not synchronized, the transmit opportunity (TXOP) may start randomly in the first and second links. TXOP can be defined as a time duration for which a STA or an AP can send frames after it has gained contention for the medium. In some implementations, sending the ICF frames on two or more links of the multi-link TWT scheme can result in the fastest link transmitting.

According to some aspects, on the non-AP MLD side, after receiving the ICF frames, the non-AP MLD can decide which STA and which link to choose to communicate with the AP MLD. The non-AP MLD can choose the STA and the link using different criteria such as, but not limited to, the STAs' parameters, the links' quality, etc. After choosing the STA and the link, the STA of the non-AP MLD can send a frame (e.g., a BSR frame, a CTS frame, etc.) on the selected link.

According to some aspects, the non-AP MILD can activate two or more radios (STAs) for the start of the TWT SP that can result in reliable and fast TXOP obtaining. In some examples, the radio power consumption may be higher than operating TWT only in one link.

According to some aspects, in high congestion, the 20 MHz bandwidth (BW) of the ICF frame may be limiting the number of STAs that can obtain the ICF frame. In some examples, the AP MILD may schedule the transmission of the ICF frame only in one link at this time.

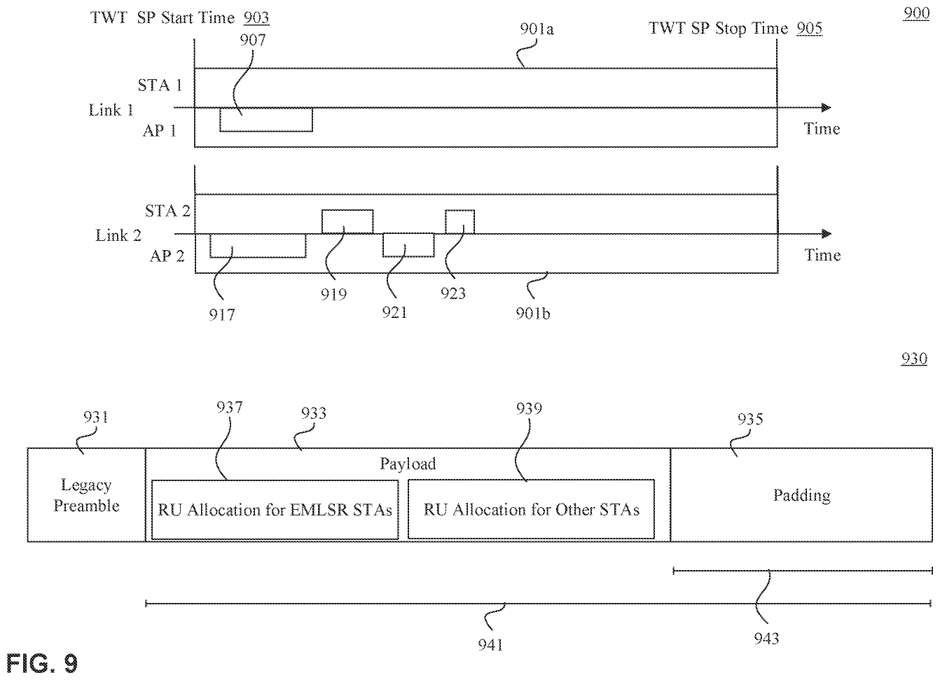

FIG. 9 illustrates an exemplary multi-link TWT flow 900 for two links with ICF frame having additional padding, according to some aspects. The multi-link TWT flow 900 can be based on the TWT schedule negotiated between an AP MLD and a non-AP MLD. FIG. 9 may be described with regard to elements of FIGS. 1-8. According to some aspects, the multi-link TWT flow 900 can be discussed with respect to the EMLSR operation mode. However, the multi-link TWT flow 900 can also be used for other operations modes.

FIG. 9 illustrates the exemplary multi-link TWT flow 900 that includes two service periods (SPs) 901a and 901b. The SP 901a is associated with a first link (Link 1) and the SP 901b is associated with a second link (Link 2).

As illustrated in FIG. 9, the SP 901a and the SP 901b can have the TWT SP start time 903 that indicates the start time for both the SP 901a and the SP 901b. In some aspects, the SP 901a can have a different start time than the SP 901b. Additionally, as illustrated in FIG. 9, the SP 901a and the SP 901b can have the TWT SP stop time 905 that indicates the stop time for both the SP 901a and the SP 901b. In some aspects, the SP 901a can have a different stop time than the SP 901b.

According to some aspects, the SP 901a associated with the first link (Link 1) is used for communication between a first STA (STA 1) of a non-AP MLD and a first AP (AP 1) of an AP MLD. Similarly, the SP 901b associated with the second link (Link 2) is used for communication between a second STA (STA 2) of the non-AP MLD and a second AP (AP 2) of the AP MLD. In some examples, the first and second STAs are EMLSR STAs. In some examples, the first and second STAs have a PM that has a first value (e.g., a value of “1”). In some examples, SP 901a and SP 901b are announced TWT SPs.

According to some aspects, the first AP can send the ICF frame 907 (e.g., a BSRP trigger frame) to the first STA on the first link and the second AP can send the ICF frame 917 (e.g., a BSRP trigger frame) to the second STA on the second link. In some implementations, the first and second APs transmit simultaneous ICF frames 907 and 917 on the first and second links at the beginning of the SPs 901a and 901b. As discussed above, the SPs 901a and 901b can be simultaneous TWT SPs. Additionally, or alternatively, the ICF frames 907 and 917 on the first and second links are not simultaneous and are transmitted with some delay (e.g., the transmissions may start at different times).

According to some aspects, the ICF frames 907 and 917 can include special transmission setup information. For example, the IFC frames 907 and 917 can include STA specific resource unit (RU) allocation information.

According to some aspects, the ICF frames 907 and 917 can include additional bits to increase the length of the ICF frames 907 and 917. By increasing the length of the ICF frames 907 and 917, the receiving non-AP MILD (that includes the first and second STAs) can determine which STA and which link to use and to switch to the selected STA and the selected link to send a response frame. In some implementations, the additional length added to the ICF frames 907 and 917 can include a link switch duration and a decision time.

According to some aspects, when the non-AP MILD receives the ICF frames 907 and 917 on the first and second links, respectively, the non-AP MLD can receive (e.g., retrieve) the RU allocation information from both of the ICF frames 907 and 917. Then, the non-AP MLD can select the STA and the link to communicate with the AP MLD (that includes the first and second APs). In some implementations, the non-AP MLD can use information such as, but not limited to, the RU allocation information, the links' quality, the STAs' parameters, the availability of the STAs, the traffic information associated with the STAs, or the like to select the STA and the link. After selecting the STA and the link, the non-AP MLD can switch to the selected STA to transmit a response frame to the ICF frame on the selected link.

For example, as illustrated in FIG. 9, the non-AP MLD can select the second STA and the second link. In response to the ICF frame 917, the second STA can send a BSR frame 919 on the second link to the second AP. In response, the second AP can send data 921 to the second AP on the second link. In response to the data 921, the second STA can send an acknowledgment (e.g., a block acknowledgment (BA)) 923 to the second AP.

FIG. 9 further illustrates an exemplary BSRP trigger frame 930 as one example of the ICF frames 907 or 917. The BSRP trigger frame 930 can include a preamble 931, a payload 933, and a padding 935. The payload 933 can include RU allocation information for EMLSR STAs 937 and RU allocation information for other STAs 939. The payload 933 can include other information such as other RU allocation information.

According to some aspects, a STA that receives the BSRP trigger frame 930 can use the rate and number of octets of preamble 931 to determine the length 941 of the payload and the padding. In some aspects, the padding 935 can have a length 943. The padding 935 can include one or more bits. In some examples, the one or more bits can have a first value (e.g., a value of “0”). In some examples, the one or more bits can have a second value (e.g., a value of “1”). By adding the padding 935, the receiving non-AP MLD (that includes the first and second STAs) can determine which STA and which link to use and to switch to the selected STA and the selected link to send a response frame. In some implementations, the length 943 of the padding 935 can include a link switch duration and a decision time. The decision time includes a time period during which the non-AP MLD can select the STA and the link. The link switch duration can include a time period during with the non-AP MLD switches to the selected STA to receive and/or transmit data.

According to some aspects, the ICF frames can trigger multiple STAs. If all the triggered STAs fail to respond to the ICF frames, then the APs obtain TXOP. As one example of the ICF frame, the MU-RTS frame can solicit identical CTS frames that are transmitted at a requested BW. Using the MU-RTS frame, the AP can determine the largest BW in which the CTS frame is transmitted. As another example of the ICF frame, the BSRP trigger frame can allocate RUs to the STAs to send BSR frames. The AP MLD can know which STAs have responded.

According to some aspects, the duration of a network allocation vector (NAV) can be selected for multiple ICF frames (e.g., ICF frames 907 and 917 of FIG. 9). In some examples, a transmitting station can resume its transmission after the data detected on the channel is transmitted and after a time specified in the data detected on the channel is passed. For example, the specified time can be a time indicated in a medium access control (MAC) header (e.g., a time/counter in the duration field of the MAC header—network allocation vector (NAV)) of the one or more packets.

According to some aspects, the duration of the NAV can be set in the ICF frame (e.g., the BSRP trigger frame). In some examples, if many STAs are available to transmit, the ICF frame can set a long duration for the NAV to the end of the TXOP. This NAV helps the AP to continue TXOP, even if the BSRP trigger frame gets no responses. If only few STAs are available, then the AP may allocate a short duration for the NAV. This short duration can be is similar to MU-RTS timeout value. If no STA responds in a link, the AP may stop operating in the link without long wasted air time.

In a non-limiting example with reference to FIG. 9, the duration of the NAV for the ICF frame 907 can be set to a first duration and the duration of the NAV for the ICF frame 917 can be set to a second duration. In this example, the first duration can be longer than the second duration.

In a non-limiting example, the length of the BSRP trigger frame can be about 140 μs. This length can include a length of about 76 μs for preamble and payload and a length (e.g., length 943) of about 64 μs for the padding (e.g., the padding 935). In this example, the duration of the short NAV can be about 120 μs. In this example, the duration of the short NAV (after the ICF frame) can include the duration of two Short Interframe Spaces (SIFS) and the duration of the response frame (e.g., the BSR frame). In other words, a first SIFS, a BSR frame, and a second SIFS are within the duration of the short NAV. In this non-limiting example, the additional duration per ICF frame, caused by triggering in two links can be less than about 50 μs.

In a non-limiting example, the EMLSR STA specific transition time (e.g., the link switch duration plus the decision time) can be about 64 μs or 128 μs. An STA with a longest padding time can be allocated first. The duration of the MU-RTS frame (with no padding) can be about 50 μs to about 80 μs. The duration of a BSRP trigger frame (with not padding) can be about 50 μs to about 80 μs. The duration of the CTS frame can be about 40 μs. The duration of the BSR frame can be about 70 μs.

However, the aspects of this disclosure are not limited to these examples and can include other values.

According to some aspects, the transmissions of the ICF frames and/or the start times of the TWT SPs can be controlled based on a prioritization of the links in the multi-link TWT. According to some implementations, the prioritization of the links can be based on the quality of the links. For example, the link with the best quality can have the highest priority and so on. According to some examples, the link quality can be based on, but is not limited to, bandwidth, throughput, noise, or the like,

According to some aspects, the non-AP MLD can measure the links' qualities and communicate the links' qualities to the AP MLD. Based on the links' qualities (or the link prioritization), the AP MLD can control the transmissions of the ICF frames and/or the start times of the TWT SPs.

In a non-limiting example having two links in the multi-link TWT scheme, the first link (used for communication between the first STA and the first AP) can have a better quality than the second link (used for communication between the second STA and the second AP). In some implementations, based on the determined qualities of the links, the AP MLD can select the first AP to send the ICF frame on the first link to the first STA. In these examples, the second AP does not send any ICF frames on the second link.

In other implementations, the AP MLD can send ICF frames on both links. For example, the first AP can send a first ICF frame on the first link to the first STA and the second AP can send a second ICF frame on the second link to the second STA. In these examples, the non-AP MLD, based on the determined qualities of the links, can ignore the second ICF frame on the second link. In other words, the second STA of the non-AP MLD can receive the second ICF frame on the second link, but then the second STA can ignore the second ICF frame. In some examples, the second STA can ignore the second ICF frame by not responding to the second ICF frame.

In other implementations, the AP MLD and/or the non-AP MLD can change the start time of one or more TWT SPs based on the determined qualities of the links. For example, the AP MLD can delay the start time of the second TWT SP that is used for the second link so that the first AP will send the first ICF frame on the first link. Additionally, or alternatively, the non-AP MLD can delay the start time of the second TWT SP that is used for the second link so that the first AP will send the first ICF frame on the first link.

Early termination mechanisms can be used for the multi-link TWT scheme to trigger the STA(s) of the non-AP MLD to transition to power save mode earlier than planned and/or terminate service periods earlier than planned. For example, as illustrated in more detail below, End of Service Period (EOSP) field in media access control (MAC) headers of MAC protocol data units (MPDUs) of PPDUs can be used for the early termination mechanisms.

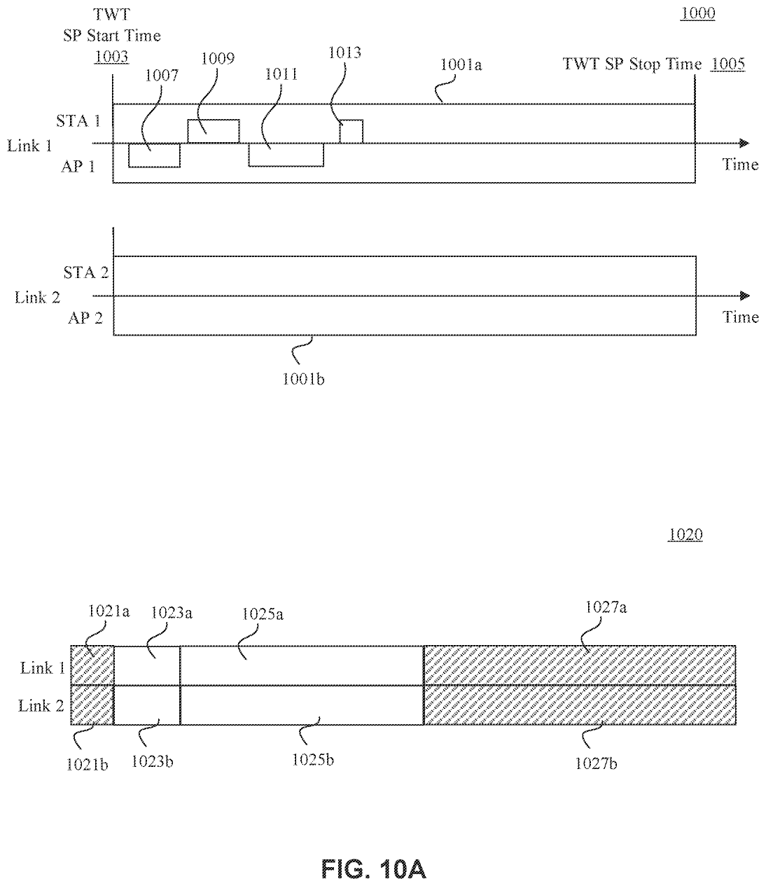

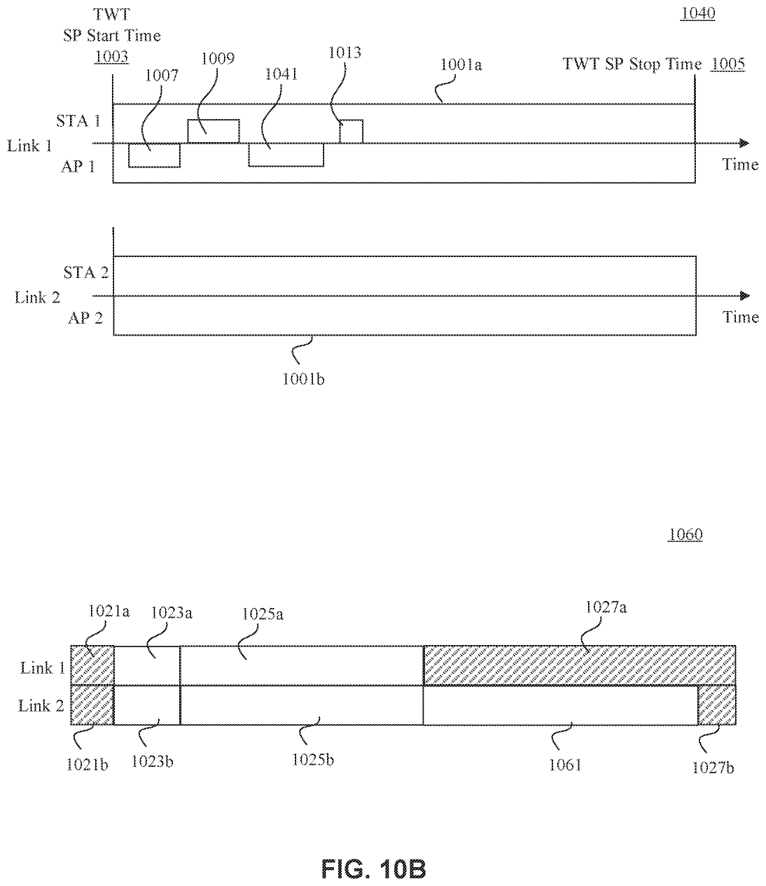

FIG. 10A illustrates an exemplary multi-link TWT flow 1000 with End of Service Period (EOSP), according to some aspects. The multi-link TWT flow 1000 can be based on the TWT schedule negotiated between an AP MLD and a non-AP MLD. FIG. 10A may be described with regard to elements of FIGS. 1-9. According to some aspects, the multi-link TWT flow 1000 can be discussed with respect to the EMLSR operation mode. However, the multi-link TWT flow 1000 can also be used for other operations modes.

The multi-link TWT flow 1000 can include two service periods (SPs) 1001a and 1001b. The SP 1001a is associated with a first link (Link 1) and the SP 1001b is associated with a second link (Link 2). FIG. 10A also illustrates a realized STA availability 1020 on the first and second links.

According to some aspects, as illustrated in the realized STA availability 1020, the first STA is not available during time period 1021a before the SP start time 1003. Similarly, the second STA is not available during time period 1021b before the SP start time 1003. According to some aspects, during the time period 1023a, the first AP can send (and the first STA can receive) an ICF frame. Similarly, during the time period 1023b, the second AP can send (and the second STA can receive) an ICF frame.

As a non-limiting example, and as discussed with respect to the realized STA availability 1020 and the TWT flow 1000, the first AP (e.g., AP 1 of an AP MLD) can send a BSRP trigger frame 1007 to the first STA (e.g., STA 1 of a non-AP MLD) on the first link (Link 1). In response, the first STA can send a BSR frame 1009 on the first link to the first AP. In response, the first AP can send a data frame 1011 to the first STA. In response to the data frame 1011, the first STA can send an acknowledgment (e.g., a block acknowledgment (BA)) 1013 to the first STA. According to some aspects, the first STA is available during time period 1025a and the second STA is unavailable (e.g., has its radio in the power save mode) or can use a low power receive radio during time period 1025b.

According to some aspects, if the AP MLD has sent all the data packets it wanted to send during the SPs 1001a and 1001b, the AP MLD can let the non-AP MLD know so that the non-AP MLD can set its STAs to the power save mode before the stop time 1005. In some implementations, the AP MLD can use EOSP field to signal that no more data packets are transmitted during SPs 1001a and 1001b. In some aspects, the EOSP field can be link specific (e.g., the EOSP field can be used to terminate the TWT SP on one link). Additionally, or alternatively, the EOSP field can be applied to two or more links (e.g., the EOSP field can be used to terminate the TWT SP on two or more links).

For example, the first AP can set the EOSP field of the last data packet (e.g., the EOSP field in the MAC headers of the MPDUs of the last PPDU) of data frame 1011 to a first value (e.g., “1”) to indicate to the first and second STAs that this data packet is the last data packet and no more packets are transmitted during the remainder of SPs 1001a and 1001b. After receiving the data frame 1011 and after sending BA 1013, the non-AP MLD can transition its STAs (the first and second STAs) to the power save move when the non-AP MLD determines that the EOSP field of the last packet of data frame 1011 is set to “1”. In this example, the first STA will be unavailable (e.g., has its radio in the power save mode) during the time period 1027a and the second STA will be unavailable (e.g., has its radio in the power save mode) during the time period 1027b.

According to some aspects, the non-AP MLD can signal the amount of buffered uplink (UL) data it has to send to the AP MLD. For example, the non-AP MLD can use the BSR frame 1009 to send the amount of the buffered UL data. In some implementations, the buffered UL data is associated to all the STAs of the non-AP MLD. After receiving the amount of the buffered UL data and depending on the amount of buffered DL data, the AP MLD can determine whether or not to set the EOSP field to the first value (e.g., “1”). In other words, if the non-AP MLD signals to the AP MLD (e.g., using the BSR frame 1009) that the non-AP MLD has no buffered UL data (e.g., non-AP MLD has transmitted its UL data), and the AP MLD transmits all its DL data using data frame 1041, then the AP MLD can set the EOSP field to the first value (e.g., “1”).

FIG. 10B illustrates an exemplary multi-link TWT flow 1040 with a TWT information frame to signal service period termination, according to some aspects. The multi-link TWT flow 1040 can be based on the TWT schedule negotiated between an AP MLD and a non-AP MLD. FIG. 10B may be described with regard to elements of FIGS. 1-9. According to some aspects, the multi-link TWT flow 1040 can be discussed with respect to the EMLSR operation mode. However, the multi-link TWT flow 1040 can also be used for other operations modes.

The multi-link TWT flow 1040 can include two service periods (SPs) 1001a and 1001b. The SP 1001a is associated with a first link (Link 1) and the SP 1001b is associated with a second link (Link 2). FIG. 10B also illustrates a realized STA availability 1060 on the first and second links.

According to some aspects, as illustrated in the realized STA availability 1060, the first STA is not available during time period 1021a before the SP start time 1003. Similarly, the second STA is not available during time period 1021b before the SP start time 1003. According to some aspects, during the time period 1023a, the first AP can send (and the first STA can receive) an ICF frame. Similarly, during the time period 1023b, the second AP can send (and the second STA can receive) an ICF frame.

As a non-limiting example, and as discussed with respect to the realized STA availability 1060 and the TWT flow 1040, the first AP (e.g., AP 1 of an AP MLD) can send a BSRP trigger frame 1007 to the first STA (e.g., STA 1 of a non-AP MLD) on the first link (Link 1). In response, the first STA can send a BSR frame 1009 on the first link to the first AP. In response, the first AP can send a data frame 1041 to the first STA. In response to the data frame 1041, the first STA can send an acknowledgment (e.g., a block acknowledgment (BA)) 1013 to the first STA. According to some aspects, the first STA is available during time period 1025a and the second STA is unavailable (e.g., has its radio in the power save mode) or can use a low power receive radio during time period 1025b.

According to some aspects, the AP MLD can send information about its availability (and/or the availabilities of its APs) to the non-AP MLD. Additionally, or alternatively, the non-AP MLD can send information about its availability (and/or the availability of its STAs) to the AP MLD. In some implementations, the AP MLD and/or the non-AP MLD can use the TWT information frame to signal their availabilities. However, other frames can also be used to signal the availabilities.

In one example, the first AP can send the TWT information frame with data frame 1041 to indicate the availability of the first AP and/or the availability of the second AP. For example, the first AP can send the TWT information frame on the first link to the first STA to indicate that the first AP will not be available on the first link. In this example, the first STA can become unavailable (e.g., set its radio in the power save mode) during the time period 1027a since the first AP will also be unavailable on the first link. In this example, the time period 1061 for the second link can be used for ICF frame transmission by the second AP. The second STA will become unavailable (e.g., set its radio in the power save mode) during the time period 1027b after the stop time 1005.

Although this example illustrates the first AP using the TWT information frame to signal its unavailability, the STA(s) of the non-AP MLD can also use the TWT information frame to signal their unavailability.

According to some aspects, the link ID bitmap subfield 797 of FIG. 7C (or an additional link ID bitmap) of the TWT information frame can be used to indicate the links on which that the APs and/or the STAs will be unavailable.

According to some aspects, the multi-link TWT scheme can also be used with STR operation mode (e.g., with STAs operating in the STR operation mode). In some implementations, the AP MLD can use announced TWT to detect whether the STA(s) of the non-AP MLD are available before the AP MLD sends DL data to the non-AP MLD. According to some aspects, the non-AP MLD operates in the STR operations mode and can allow the links to operate independently (e.g., the STAs of the non-AP MLD operate independently on their respective link).

According to some aspects, since the operations of the STAs may be different on each link, the AP MLD will detect STA availability on the links separately for each link before the AP MLD may send DL data on the links. For example, in the announced TWT SP, the STA availability indication can be used to skip a TWT SP. If the STA does not respond to be available for the AP, then the STA does not miss DL data since the AP knows not to send the DL data. The link specific availability check may allow the STR STA to not be available on one or more links.

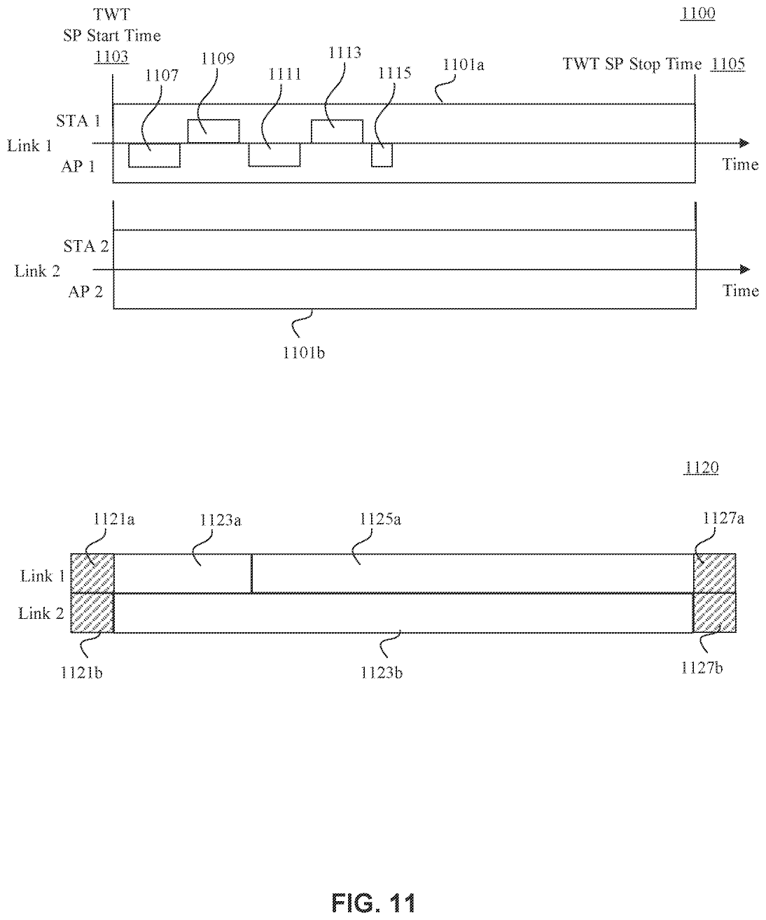

FIG. 11 illustrates an exemplary multi-link TWT flow 1100 for two links for STR STAs, according to some aspects. The multi-link TWT flow 1100 can be based on the TWT schedule negotiated between an AP MLD and a non-AP MLD. FIG. 11 may be described with regard to elements of FIGS. 1-10. According to some aspects, the multi-link TWT flow 1100 can be discussed with respect to the STR operation mode. However, the multi-link TWT flow 1100 can also be used for other operations modes.

FIG. 11 illustrates the exemplary multi-link TWT flow 1100 that includes two service periods (SPs) 1101a and 1101b. The SP 1101a is associated with a first link (Link 1) and the SP 1101b is associated with a second link (Link 2). FIG. 11 also illustrates a realized STA availability 1120 on the first and second links.

As illustrated in FIG. 11, the SP 1101a and the SP 1101b can have the TWT SP start time 1103 that indicates the start time for both the SP 1101a and the SP 1101b. In some aspects, the SP 1101a can have a different start time than the SP 1101b. Additionally, as illustrated in FIG. 11, the SP 1101a and the SP 1101b can have the TWT SP stop time 1105 that indicates the stop time for both the SP 1101a and the SP 1101b. In some aspects, the SP 1101a can have a different stop time than the SP 1101b.

According to some aspects, the SP 1101a associated with the first link (Link 1) is used for communication between a first STA (STA 1) of a non-AP MLD and a first AP (AP 1) of an AP MLD. Similarly, the SP11601b associated with the second link (Link 2) is used for communication between a second STA (STA 2) of the non-AP MLD and a second AP (AP 2) of the AP MLD. In some examples, the first and second STAs are STR STAs. In some examples, the first and second STAs have a PM that has a first value (e.g., a value of “1”). In some examples, SP 1101a and SP 1101b are announced TWT SPs.

According to some aspects, as illustrated in the realized STA availability 1120, the first STA is not available during time period 1121a before the SP start time 1103 and is not available during time period 1127a after the SP stop time 1105. Similarly, the second STA is not available during time period 1121b before the SP start time 1103 and is not available during time period 1127b after the SP stop time 1105.

According to some aspects, during the time period 1121a, the first AP can send (and the first STA can receive) an ICF frame. Similarly, during the time periods 1121b, the second AP can send (and the second STA can receive) an ICF frame. In some implementations, the time period 1121a of the first link can have the same (or substantially the same (e.g., within ±30 μs or less)) start time and stop time as the time period 1121b of the second link. Alternatively, the time period 1121a of the first link can have different start time and/or stop time as the time periods 1121b of the second link.

As a non-limiting example, and as discussed with respect to the realized STA availability 1120 and the TWT flow 1100, the first AP (e.g., AP 1 of an AP MLD) can send a BSRP trigger frame 1107 to the first STA (e.g., STA 1 of a non-AP MLD) on the first link (Link 1). In response, the first STA can send a BSR frame 1109 on the first link to the first AP. In response, the first AP can send a trigger frame 1111 to trigger the first STA to send its data. For example, in response to the trigger frame 1111, the first STA transmits data 1113 to the first AP on the first link. In response to the data 1113, the first AP can send an acknowledgment (e.g., a block acknowledgment (BA)) 1115 to the first STA.

In this example, during the time period 1123a (that can include the BSRP trigger frame 1107 and BSR frame 1109), the first STA may not be available for DL data (e.g., available to receive DL data) on the first link. During the time period 1123a, the first STA may be available to receive an ICF frame (e.g., the BSRP trigger frame 1107) and respond to the ICF frame (e.g., BSR frame 1109). However, by sending the BSR frame 1109, the first STA can indicate to the first AP that the first STA will be available for DL data on the first link. Therefore, the first STA is available for DL data during time period 1125a. In this example, the second STA is not available for DL data on the second link during the time period 1123b. As discussed above, in the STR operation mode, each STA (on its corresponding link) is transitioned to become available for receiving DL data separately from other STAs, according to some aspects. In some examples, the first STA has transitioned to become available for receiving DL data in response to the ICF frame (e.g., the BSRP trigger frame 1107). However, the second STA has not transitioned and is not available for DL data on the second link during the time period 1123b.

According to some aspects, EOSP field can also be used with the STR operation mode to signal the termination of a TWT SP and/or to signal to an STA to transition to power save mode before the TWT SP has ended. According to some aspects the EOSP field can be link specific when used with the STR operation mode.

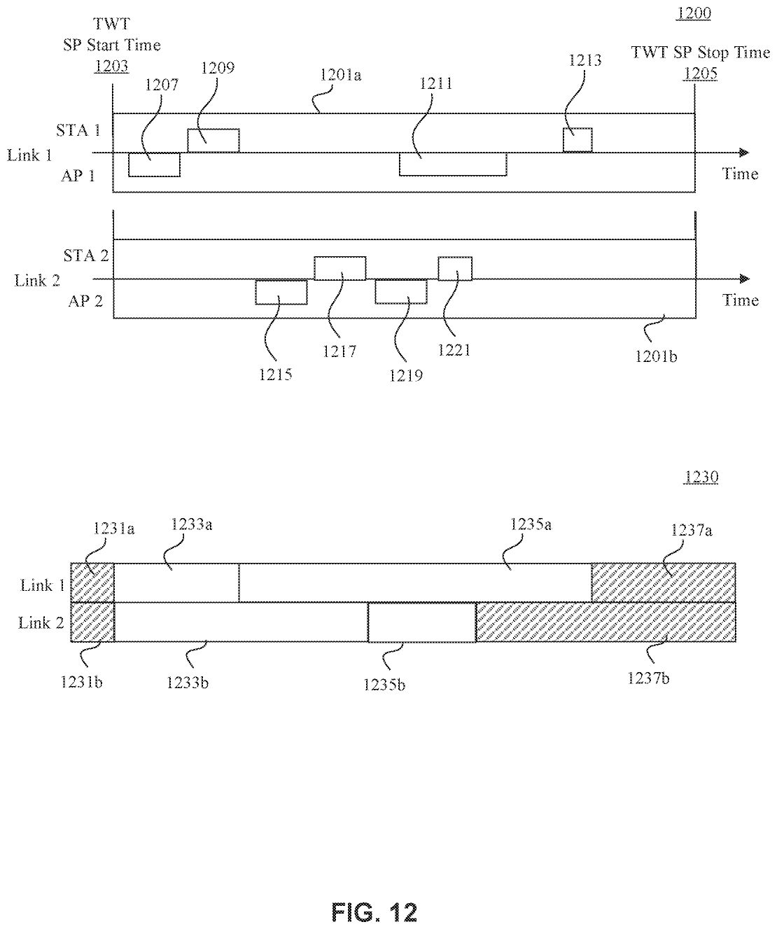

FIG. 12 illustrates an exemplary multi-link TWT flow 1200 with End of Service Period (EOSP), according to some aspects. The multi-link TWT flow 1200 can be based on the TWT schedule negotiated between an AP MLD and a non-AP MLD. FIG. 12 may be described with regard to elements of FIGS. 1-11. According to some aspects, the multi-link TWT flow 1200 can be discussed with respect to the STR operation mode. However, the multi-link TWT flow 1200 can also be used for other operations modes.

The multi-link TWT flow 1200 can include two service periods (SPs) 1201a and 1201b. The SP 1201a is associated with a first link (Link 1) and the SP 1201b is associated with a second link (Link 2). FIG. 12 also illustrates a realized STA availability 1230 on the first and second links. According to some aspects, the communication between the first AP and the first STA on the first link can be independent from the communication between the second AP and the second STA on the second link.

According to some aspects, as illustrated in the realized STA availability 1230, the first STA is not available during time period 1231a before the SP start time 1203. During the time period 1233a, the first STA may not be available for DL data (e.g., available to receive DL data) on the first link. During the time period 1233a, the first AP (e.g., AP 1 of an AP MLD) can send a BSRP trigger frame 1207 to the first STA (e.g., STA 1 of a non-AP MLD) on the first link (Link 1). In response, the first STA can send a BSR frame 1209 on the first link to the first AP. Based on the received BSR frame 1209, the first AP determines that the first STA can be available for DL data. The first STA is now available for DL data during time period 1235a. In this example, the first AP can send a data frame 1211 to the first STA. In response to the data frame 1211, the first STA can send an acknowledgment (e.g., a block acknowledgment (BA)) 1213 to the first STA.

According to some aspects, if the first AP has sent all the data packets it wanted to send during the SP 1201a, the first AP can let the first STA know so that the first STA can transition to the power save mode before the stop time 1205. In some implementations, the first AP can use the EOSP field to signal that no more data packets are transmitted during SP 1201a. In some aspects, the EOSP field can be link specific (e.g., the EOSP field can be used to terminate the TWT SP on one link). For example, the first AP can set the EOSP field of the last data packet (e.g., the EOSP field in the MAC headers of the MPDUs of the last PPDU) of data frame 1211 to a first value (e.g., “1”) to indicate to the first STA that this data packet is the last data packet and no more packets are transmitted during the remainder of SP 1201a. After receiving the data frame 1211 and after sending BA 1213, the first STA can transition to the power save move when the first STA determines that the EOSP field of the last packet of data frame 1211 is set to “1”. In this example, the first STA will be unavailable (e.g., has its radio in the power save mode) during the time period 1237a.

According to some aspects, as illustrated in the realized STA availability 1230, the second STA is not available during time period 1231b before the SP start time 1203. During the time period 1233b, the second STA may not be available for DL data (e.g., unavailable to receive DL data) on the second link. During the time period 1233b, the second AP (e.g., AP 2 of an AP MLD) can send a BSRP trigger frame 1215 to the second STA (e.g., STA 2 of a non-AP MLD) on the second link (Link 2). In response, the second STA can send a BSR frame 1217 on the second link to the second AP. Based on the received BSR frame 1217, the second AP determines that the second STA can be available for DL data. The second STA is now available for DL data during time period 1235b. In this example, the second AP can send a data frame 1219 to the second STA. In response to the data frame 1219, the second STA can send an acknowledgment (e.g., a block acknowledgment (BA)) 1221 to the second STA.

According to some aspects, if the second AP has sent all the data packets it wanted to send during the SP 1201b, the second AP can let the second STA know so that the second STA can transition to the power save mode before the stop time 1205. In some implementations, the second AP can use the EOSP field to signal that no more data packets are transmitted during SP 1201b. In some aspects, the EOSP field can be link specific (e.g., the EOSP field can be used to terminate the TWT SP on one link). For example, the second AP can set the EOSP field of the last data packet (e.g., the EOSP field in the MAC headers of the MPDUs of the last PPDU) of data frame 1219 to a first value (e.g., “1”) to indicate to the first STA that this data packet is the last data packet and no more packets are transmitted during the remainder of SP 1201b. After receiving the data frame 1219 and after sending BA 1221, the second STA can transition to the power save move when the second STA determines that the EOSP field of the last packet of data frame 1211 is set to “1”. In this example, the second STA will be unavailable (e.g., has its radio in the power save mode) during the time period 1237b.

According to some aspects, the AP MLD and the non-AP MLD can communicate over two links, where on one link (e.g., the first link) a first STA of the non-AP MLD uses TWT scheme, and on the other link (e.g., the second link) a second STA of the non-AP MLD is in active mode. In some implementations, the non-AP MLD may not use data buffering/accumulation of the link that uses the TWT scheme. In other words, the non-AP MLD can skip the first STA (the STA using the TWT scheme) and can send its data on the second STA (the STA in active mode). In these examples, the non-AP MLD can determine whether any of its STAs are in an active mode (and/or do not use TWT scheme). In response to determining that the second STA is in the active mode (and/or does not use TWT scheme), the non-AP MLD uses the second STA for communicating with the AP MLD.

According to some aspects, the second STA in the active mode can transmit (and/or receive) data at any time. Additionally, the AP can transmit data on the second link (associated with the second STA) when the AP has data to transmit. In other words, the AP does not need to wait for TWT SPs.

According to some aspects, the non-AP MLD can still operate and use the first STA that used the TWT scheme. In these examples, the non-AP MLD can be prepared to transition its STAs to the TWT scheme when needed. For example, the non-AP MLD can transition its second STA (which is in the active mode) to the TWT scheme that the non-AP MLD is using for its first STA.

According to some aspects, the first STA may transmit a TWT information frame to skip one or more TWT SPs as discussed above. Additionally, or alternatively, the first STA may not be available for one or more announced TWT SPs.

According to some aspects, the AP MLD and/or the non-AP MLD can store and operate based on a TID-to-link mapping. For example, different traffics with different traffic identifiers (TIDs) can be mapped to different links. In some implementations, some links can operate based on the TWT scheme and some links can have STAs that are in the active mode. In some examples, one TID traffic can be transmitted periodically.

According to some aspects, the time duration of the TWT SPs for the multi-link TWT scheme can be determined based on the parameters of the links for which the TWT SPs are being configured. Assuming two links (the first and second links) being used for communication between the non-AP MLD and the AP MLD, the TWT SPs on the first link can have the time duration 405 and the TWT SPs on the second link can have the time duration 415 as shown in FIG. 4. According to some implementations, the time duration 405 can be the same or substantially the same (e.g., within ±30 μs or less) as time duration 415. The time duration 405 and the time duration 415 can be determined based on the parameters of the first and second links.

For example, the first and second links can have different quality of services (such as, but not limited to, throughputs). In some examples, the time duration 405 and the time duration 415 can be determined based on the links and their quality of services. In some examples, the time duration 405 and the time duration 415 can be determined based on the link with the lowest throughput. In some examples, the time duration of the TWT SP can contain the transmission time of data (e.g., the transmission time of UL data and transmission time of DL data), time for ACK and channel access overhead, re-transmission time, and/or delayed start time. According to some aspects, the duration time of the TWT SPs on multiple links can be determined based on the slowest link. For example, if the first link is slower (e.g., has lower throughput and/or is less efficient) than the second link, the time duration 405 and the time duration 415 is determined based on the first link. In other words, the time duration 405 and the time duration 415 can be the transmission time of data (e.g., the transmission time of UL data and transmission time of DL data) plus the time for ACK and channel access overhead plus the re-transmission time for the first link.

In some examples, if the determined duration time is long on the “faster link”, for example link with higher throughput and/or lower latency, (e.g., the second link), the AP associated to that link can use early termination mechanism to terminate the TWT SP.

According to some aspects using the unannounced TWT, the AP MLD (or one or more APs of the AP MLD) can send data to the non-AP MLD (or corresponding STA of the non-AP MILD) without receiving an indication from the STA indicating the availability of the STA. According to some implementations, an STA operating in the EMLSR operation mode does not differentiate between the announced TWT SPs and the unannounced TWT SPs and is configured to receive and use ICF frames. Alternatively, the STAs operating in the STR or NSTR, differentiate between the announced TWT SPs and the unannounced TWT SPs. In some examples, in the unannounced TWT SPs, the STA is to be available or there is a risk that the STA loses DL data.

According to some aspects using the triggered TWT SP, the AP MLD (or one or more APs of the AP MLD) sends a trigger frame to the non-AP MLD (or corresponding STA of the non-AP MLD) in the TWT SP.

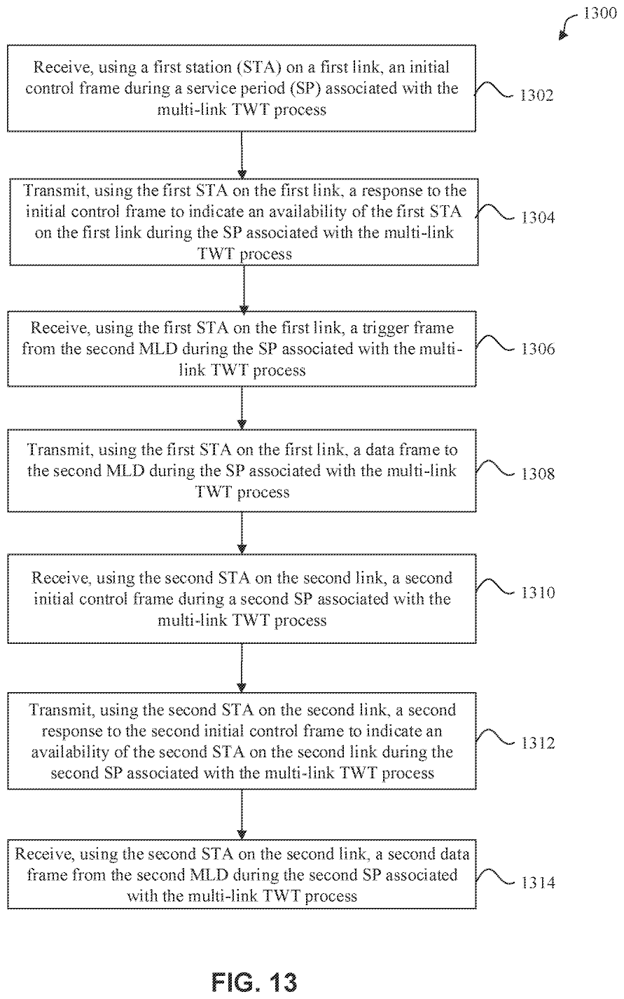

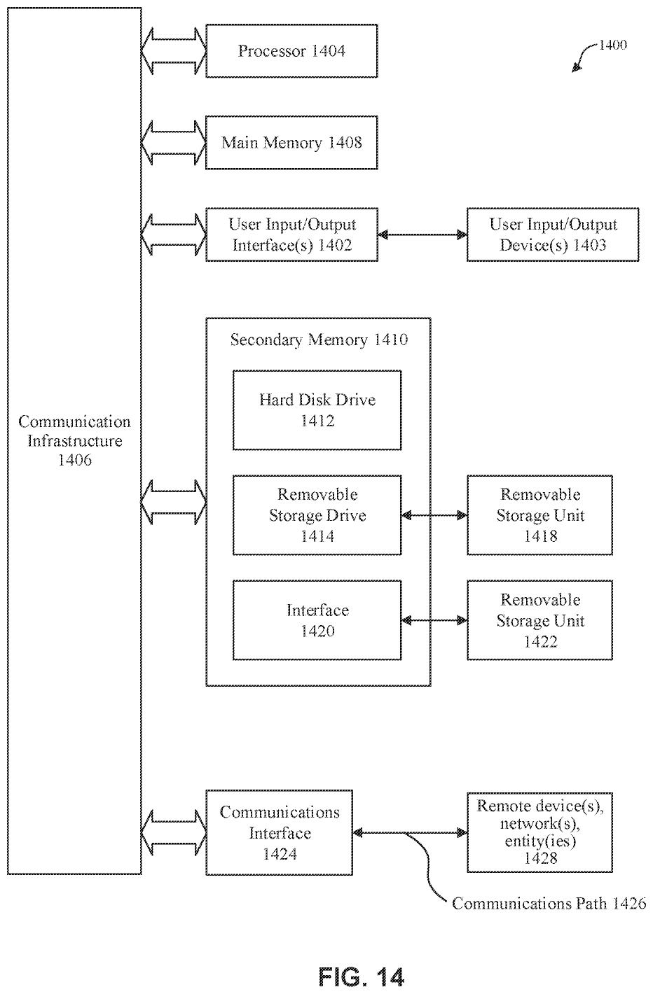

FIG. 13 illustrates an example method 1300 for a wireless system supporting and implementing a multi-link TWT scheme/process for multi-link wireless communication networks such as a wireless local area network (WLAN), according to some aspects. As a convenience and not a limitation, FIG. 13 may be described with regard to elements of FIGS. 1-12. Method 1300 may represent the operation of an electronic device (e.g., a non-AP MLD as discussed in this disclosure) implementing the multi-link TWT scheme/process. Similar method can be implemented by an AP MLD. Method 1300 may also be performed by system 200 of FIG. 2 and/or computer system 1400 of FIG. 14. But method 1300 is not limited to the specific aspects depicted in those figures and other systems may be used to perform the method as will be understood by those skilled in the art. It is to be appreciated that not all operations may be needed, and the operations may not be performed in the same order as shown in FIG. 13.

According to some aspects, method 1300 can be implemented by a non-AP MILD having a first station (STA) associated with a first link of a wireless network and a second STA associated with a second link of the wireless network. The first STA can be configured to communicate with a second MLD (e.g., an AP MLD) over the first link using a multi-link target wake time (TWT) process and the second STA can be configured to communicate with the second MLD over the second link using the multi-link TWT process.

At 1302, an initial control frame (ICF) is received during a service period (SP) associated with the multi-link TWT process. For example, the first STA can receive the ICF frame on the first link during the SP associated with the multi-link TWT process. As discussed above, the ICF frame can include a BSRP trigger frame, a MU-RTS frame, or the like. The first STA can receive the ICF frame from the second MLD.

At 1304, in response to receiving the ICF frame, a response is sent to the second MLD. For example, the first STA can transmit a response to the ICF frame on the first link to indicate an availability of the first STA on the first link during the SP (or a portion of the SP) associated with the multi-link TWT process. According to some aspects, the response to the ICF frame can also indicate the availability of the second STA on the second link during a second SP (or a portion of the second SP) associated with the multi-link TWT process. For example, for the non-AP MLD operating in the EMLSR operation mode, when the first STA is available on the first link during a portion of the SP, the second STA is unavailable or uses the low power receive radio during that portion in the second SP. Additionally, or alternatively, the response to the ICF frame can include a frame (such as, but not limited to, a QoS Null frame) to signal that the second STA on the second link is unavailable (e.g., during the rest of the second SP). In some examples, the response can include a BSR frame, a CTS frame, or the like.

At 1306, a trigger frame is received from the second MLD during the SP associated with the multi-link TWT process. For example, the first STA can receive, on the first link, a trigger frame from the second MLD during the SP associated with the multi-link TWT process. In some implementations, after the second MILD receives the response from the first STA and determines that the first STA is available on the first link during the SP (or the portion of the SP) associated with the multi-link TWT process, the second MILD can send the trigger frame to the first STA. The trigger frame can trigger the first STA to send data frame. Additionally, or alternatively, the first STA can receive DL data from the second MLD.

At 1308, a data frame is transmitted to the second MLD during the SP associated with the multi-link TWT process. For example, in response to the trigger frame, the first STA can transmit, on the first link, a data frame to the second MLD during the SP associated with the multi-link TWT process. The first STA can receive an acknowledgment from the second MLD in response to the transmitted data frame. Additionally, or alternatively, if the first STA receives DL data at 1304, the first STA can transmit, on the first link, an acknowledgment to the second MLD during the SP associated with the multi-link TWT process.

Additionally, or alternatively, the non-AP MLD and the AP MLD can also communicate on the second link during a second SP (or a portion of the second SP) associated with the multi-link TWT process. In some implementations, the first and second SPs are synchronized or substantially synchronized. For example, the start times of the first and second SPs are synchronized or substantially synchronized (e.g., within ±30 μs or less). Additionally, or alternatively, the stop times of the first and second SPs are synchronized or substantially synchronized (e.g., within ±30 μs or less).

For example, at 1310, a second ICF frame is received on the second link during the second SP associated with the multi-link TWT process. For example, the second STA can receive, on the second link, the second ICF frame during the second SP associated with the multi-link TWT process. In some implementations, the second ICF frame can include a BSRP trigger frame, a MU-RTS frame, or the like. The second STA can receive the ICF frame from the second MLD.

At 1312, a second response to the second ICF frame is transmitted to the second MLD. For example, the second STA can transmit, on the second link, the response to the second ICF frame to indicate an availability of the second STA on the second link during the second SP (or a portion of the second SP) associated with the multi-link TWT process. According to some aspects, the response to the ICF frame can also indicate the availability of the first STA on the first link during the SP (or a portion of the SP). For example, for the non-AP MLD operating in the EMLSR operation mode, when the second STA is available on the second link during a portion of the second SP, the first STA is unavailable or uses the low power receive radio during that portion in the SP. Additionally, or alternatively, the response to the ICF frame can include a frame (such as, but not limited to, a QoS Null frame) to signal that the first STA on the first link is unavailable (e.g., during the rest of the SP). In some examples, the second response can include a BSR frame, a CTS frame, or the like.

At 1314, a second data frame is received on the second link from the second MILD during the second SP associated with the multi-link TWT process. For example, the second STA can receive, on the second link, the second data frame from the second MLD during the second SP associated with the multi-link TWT process. In response to the received second data frame, the second STA can send an acknowledgment on the second link to the second MLD during the second SP associated with the multi-link TWT process.

Additionally, or alternatively, the second STA can receive a second trigger frame, send a second data frame, and receive an acknowledgment on the second link and during the second SP associated with the multi-link TWT process.

According to some aspects, the response to the ICF on the first link can indicate that the second STA is unavailable. In some implementations, operations 1310-1314 can be performed using the first STA and on the first link.

According to some aspects, the data frame(s) transmitted by the first STA and/or the second STA can include a TWT information frame that indicates the availability of the first STA during a rest of the SP and an availability of the second STA during the second SP associated with the multi-link TWT process. Additionally, or alternatively, the data frame(s) transmitted by AP MLD can include a TWT information frame that indicates the availability of the first AP of the AP MLD during a rest of the SP and an availability of the second AP of the AP MLD during the second SP associated with the multi-link TWT process.

According to some aspects, the data frame(s) transmitted by the first STA and/or the second STA can include a TWT information frame that indicates one or more SPs associated with the multi-link TWT process after the SP and/or the second SP are suspended. Additionally, or alternatively, the TWT information frame can indicate that the suspended SPs are resumed.

According to some aspects, the method 1300 can further include receiving, using the first STA on the first link, a data frame from the second MLD during the SP associated with the multi-link TWT process. Method 1300 can further include determining that an End Of Service Period (EOSP) field in a media access control (MAC) header associated with a last one of one or more packets of the data frame is set to a first value (e.g., “1”) to indicate that no more packets will be transmitted within the SP. Method 1300 can further include transitioning the first STA and the second STA to a power save mode in response to the determination. In some implementations, when EOSP is set to a second value (e.g., “0”), more packets are to be transmitted by the AP MLD.

According to some aspects, the method 1300 can further include receiving, using the first STA on the first link, a data frame from the second MLD during the SP associated with the multi-link TWT process. The data frame can include a TWT information frame indicating that the second MLD is unavailable on the first link. The method can further include transitioning the first STA to a power save mode in response to the reception of the TWT information frame.

According to some aspects, the non-AP MLD can be operating in an enhanced multi-link single radio (EMLSR) operation mode, a simultaneous transmit and receive (STR) operation mode, or a non-simultaneous transmit and receive (NSTR) operation mode.

According to some aspects, the method 1300 can also include receiving, using the first STA on the first link, a first data frame from the second MLD during the SP associated with the multi-link TWT process and receiving, using the second STA on the second link, a second data frame from the second MLD during a second SP associated with the multi-link TWT process. The method 1300 can further include determining that a first EOSP field in a first MAC header associated with a last one of one or more packets of the first data frame is set to a first value to indicate that no more packets will be transmitted within the SP. The method 1300 can also include transitioning the first STA to a power save mode in response to the determination. The method 1300 can also include determining that a second EOSP field in a second MAC header associated with a last one of one or more packets of the second data frame is set to the first value to indicate that no more packets will be transmitted within the second SP and transitioning the second STA to the power save mode in response to the determination.

According to some aspects, the multi-link TWT process includes the SP associated with the first link and a second SP associated with the second link, wherein a time duration for the SP and the second SP is determined based on a first quality of service of the first link and a second quality of service of the second link.

Various aspects can be implemented, for example, using one or more computer systems, such as computer system 1400 shown in FIG. 14. Computer system 1400 can be any well-known computer capable of performing the functions described herein such as devices 110, 120 of FIGS. 1A and 1i, or 200 of FIG. 2. Computer system 1400 includes one or more processors (also called central processing units, or CPUs), such as a processor 1404. Processor 1404 is connected to a communication infrastructure 1406 (e.g., a bus.) Computer system 1400 also includes user input/output device(s) 1403, such as monitors, keyboards, pointing devices, etc., that communicate with communication infrastructure 1406 through user input/output interface(s) 1402. Computer system 1400 also includes a main or primary memory 1408, such as random access memory (RAM). Main memory 1408 may include one or more levels of cache. Main memory 1408 has stored therein control logic (e.g., computer software) and/or data.

Computer system 1400 may also include one or more secondary storage devices or memory 1410. Secondary memory 1410 may include, for example, a hard disk drive 1412 and/or a removable storage device or drive 1414. Removable storage drive 1414 may be a floppy disk drive, a magnetic tape drive, a compact disk drive, an optical storage device, tape backup device, and/or any other storage device/drive.

Removable storage drive 1414 may interact with a removable storage unit 1418. Removable storage unit 1418 includes a computer usable or readable storage device having stored thereon computer software (control logic) and/or data. Removable storage unit 1418 may be a floppy disk, magnetic tape, compact disk, DVD, optical storage disk, and/any other computer data storage device. Removable storage drive 1414 reads from and/or writes to removable storage unit 1418 in a well-known manner.

According to some aspects, secondary memory 1410 may include other means, instrumentalities or other approaches for allowing computer programs and/or other instructions and/or data to be accessed by computer system 1400. Such means, instrumentalities or other approaches may include, for example, a removable storage unit 1422 and an interface 1420. Examples of the removable storage unit 1422 and the interface 1420 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 1400 may further include a communication or network interface 1424. Communication interface 1424 enables computer system 1400 to communicate and interact with any combination of remote devices, remote networks, remote entities, etc. (individually and collectively referenced by reference number 1428). For example, communication interface 1424 may allow computer system 1400 to communicate with remote devices 1428 over communications path 1426, which may be wired and/or wireless, and which may include any combination of LANs, WANs, the Internet, etc. Control logic and/or data may be transmitted to and from computer system 1400 via communication path 1426.

The operations in the preceding aspects can be implemented in a wide variety of configurations and architectures. Therefore, some or all of the operations in the preceding aspects may be performed in hardware, in software or both. In some aspects, a tangible, non-transitory apparatus or article of manufacture includes a tangible, non-transitory computer useable or readable medium having control logic (software) stored thereon is also referred to herein as a computer program product or program storage device. This includes, but is not limited to, computer system 1400, main memory 1408, secondary memory 1410 and removable storage units 1418 and 1422, as well as tangible articles of manufacture embodying any combination of the foregoing. Such control logic, when executed by one or more data processing devices (such as computer system 1400), causes such data processing devices to operate as described herein.

Based on the teachings contained in this disclosure, it will be apparent to persons skilled in the relevant art(s) how to make and use aspects of the disclosure using data processing devices, computer systems and/or computer architectures other than that shown in FIG. 14. In particular, aspects may operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more, but not all, exemplary aspects of the disclosure as contemplated by the inventor(s), and thus, are not intended to limit the disclosure or the appended claims in any way.

While the disclosure has been described herein with reference to exemplary aspects for exemplary fields and applications, it should be understood that the disclosure is not limited thereto. Other aspects and modifications thereto are possible, and are within the scope and spirit of the disclosure. For example, and without limiting the generality of this paragraph, aspects are not limited to the software, hardware, firmware, and/or entities illustrated in the figures and/or described herein. Further, aspects (whether or not explicitly described herein) have significant utility to fields and applications beyond the examples described herein.

Aspects have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. In addition, alternative aspects may perform functional blocks, steps, operations, methods, etc. using orderings different from those described herein.

References herein to “one aspect,” “an aspect,” “some aspects,” “an example,” “some examples” or similar phrases, indicate that the aspect described may include a particular feature, structure, or characteristic, but every aspect may not necessarily include the particular feature, structure, or characteristic. Moreover, such phrases are not necessarily referring to the same aspect. Further, when a particular feature, structure, or characteristic is described in connection with an aspect, it would be within the knowledge of persons skilled in the relevant art(s) to incorporate such feature, structure, or characteristic into other aspects whether or not explicitly mentioned or described herein.

The breadth and scope of the disclosure should not be limited by any of the above-described exemplary aspects, but should be defined only in accordance with the following claims and their equivalents.

As described above, aspects of the present technology may include the gathering and use of data available from various sources, e.g., to improve or enhance functionality. The present disclosure contemplates that in some instances, this gathered data may include personal information data that uniquely identifies or can be used to contact or locate a specific person. Such personal information data can include demographic data, location-based data, telephone numbers, email addresses, Twitter ID's, home addresses, data or records relating to a user's health or level of fitness (e.g., vital signs measurements, medication information, exercise information), date of birth, or any other identifying or personal information. The present disclosure recognizes that the use of such personal information data, in the present technology, may be used to the benefit of users.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should only occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of, or access to, certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology may be configurable to allow users to selectively “opt in” or “opt out” of participation in the collection of personal information data, e.g., during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure may broadly cover use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

What is claimed is:

1. A multi-link device (MLD), comprising:
a first station (STA) associated with a first link of a wireless network and configured to communicate with a second MLD over the first link using a multi-link target wake time (TWT) process;
a second STA associated with a second link of the wireless network and configured to communicate with the second MLD over the second link using the multi-link TWT process; and
one or more processors communicatively coupled to the first and second STAs and configured to:
receive, using the first STA on the first link, an initial control frame during a first service period (SP) associated with the multi-link TWT process; and
transmit, using the first STA on the first link, a response to the initial control frame to indicate an availability of the first STA on the first link during the first SP and to indicate an availability of the second STA on the second link during a second SP associated with the multi-link TWT process, wherein the second SP is substantially synchronized with the first SP.

2. The MLD of claim 1, wherein the one or more processors are further configured to:
receive, using the first STA on the first link, a trigger frame from the second MLD during the first SP; and
transmit, using the first STA on the first link, a data frame to the second MLD during the first SP.

3. The MLD of claim 2, wherein the one or more processors are further configured to:
receive, using the second STA on the second link, a second initial control frame during the second SP;
transmit, using the second STA on the second link, a second response to the second initial control frame to indicate an availability of the second STA on the second link during the second SP; and
receive, using the second STA on the second link, a second data frame from the second MLD during the second SP.

4. The MLD of claim 2, wherein the response to the initial control frame indicates that the second STA on the second link is unavailable and wherein the one or more processors are further configured to:
receive, using the first STA on the first link, a second initial control frame during the first SP;
transmit, using the first STA on the first link, a second response to the second initial control frame to indicate the availability of the first STA on the first link; and
receive, using the first STA on the first link, a second data frame from the second MLD during the first SP.

5. The MLD of claim 1, wherein the one or more processors are further configured to:
receive, using the first STA on the first link, a trigger frame from the second MLD during the first SP; and
transmit, using the first STA on the first link, a data frame to the second MLD during the first SP,
wherein the data frame comprises a TWT information frame indicating the availability of the first STA during a rest of the first SP and the availability of the second STA during a rest of the second SP.

6. The MLD of claim 1, wherein the one or more processors are further configured to:
receive, using the first STA on the first link, a trigger frame from the second MLD during the first SP; and
transmit, using the first STA on the first link, a data frame to the second MLD during the first SP,
wherein the data frame comprises a TWT information frame indicating one or more other SPs associated with the multi-link TWT process after the first SP is suspended.

7. The MLD of claim 1, wherein the one or more processors are further configured to:
receive, using the first STA on the first link, a data frame from the second MLD during the first SP;
determine that an End Of Service Period (EOSP) field in a media access control (MAC) header associated with a last one of one or more packets of the data frame is set to a first value to indicate that no more packets will be transmitted within the first SP; and
in response to the determination, transition the first STA and the second STA to a power save mode.

8. The MLD of claim 1, wherein the one or more processors are further configured to:
receive, using the first STA on the first link, a data frame from the second MLD during the first SP, wherein the data frame comprises a TWT information frame indicating that the second MLD is unavailable on the first link; and
in response to the reception of the TWT information frame, transition the first STA to a power save mode.

9. The MLD of claim 1, wherein:
the MLD is operating in an enhanced multi-link single radio (E-LSR) operation mode, a simultaneous transmit and receive (STR) operation mode, or a non-simultaneous transmit and receive (NSTR) operation mode,
the availability of the first STA on the first link includes at least one of the availability of the first STA to receive the initial control frame or the availability of the first STA to receive downlink (DL) data on the first link during the first SP, and
the initial control frame is different from the DL data.

10. The MLD of claim 1, wherein the one or more processors are further configured to:
receive, using the first STA on the first link, a first data frame from the second MLD during the first SP;
receive, using the second STA on the second link, a second data frame from the second MLD during the second SP;
determine that a first End Of Service Period (EOSP) field in a first media access control (MAC) header associated with a last one of one or more packets of the first data frame is set to a first value to indicate that no more packets will be transmitted within the first SP;
transition the first STA to a power save mode;
determine that a second EOSP field in a second MAC header associated with a last one of one or more packets of the second data frame is set to the first value to indicate that no more packets will be transmitted within the second SP; and
transition the second STA to the power save mode.

11. The MLD of claim 1, wherein the multi-link TWT process comprises the first SP associated with the first link and the second SP, wherein a time duration for the first SP and the second SP is determined based on a first quality of service of the first link and a second quality of service of the second link.

12. A method, comprising:
receiving, using a first station (STA) of a first multi-link device (MLD) and on a first link of a wireless network, an initial control frame from a second MLD during a first service period (SP) associated with a multi-link target wake time (TWT) process,
wherein the first MLD further comprises a second STA associated with a second link of the wireless network and configured to communicate with the second MLD over the second link using the multi-link TWT process; and
transmitting, using the first STA on the first link, a response to the initial control frame to indicate an availability of the first STA on the first link during the first SP and to indicate an availability of the second STA on the second link during a second SP associated with the multi-link TWT process, wherein the second SP is substantially synchronized with the first SP.

13. The method of claim 12, further comprising:
receiving, using the first STA on the first link, a trigger frame from the second MLD during the first SP; and
transmitting, using the first STA on the first link, a data frame to the second MLD during the first SP.

14. The method of claim 13, further comprising:
receiving, using the second STA on the second link, a second initial control frame during the second SP;
transmitting, using the second STA on the second link, a second response to the second initial control frame to indicate an availability of the second STA on the second link during the second SP associated with the multi-link TWT process; and
receiving, using the second STA on the second link, a second data frame from the second MILD during the second SP associated with the multi-link TWT process.

15. The method of claim 12, further comprising:
receiving, using the first STA on the first link, a trigger frame from the second MLD during the first SP; and
transmitting, using the first STA on the first link, a data frame to the second MLD during the first SP,
wherein the data frame comprises a TWT information frame indicating the availability of the first STA during a rest of the SP and the availability of the second STA during a rest of the second SP.

16. The method of claim 12, further comprising:
receiving, using the first STA on the first link, a trigger frame from the second MLD during the first SP; and
transmitting, using the first STA on the first link, a data frame to the second MLD during the first SP,
wherein the data frame comprises a TWT information frame indicating one or more other SPs associated with the multi-link TWT process after the first SP is suspended.

17. The method of claim 12, further comprising:
receiving, using the first STA on the first link, a data frame from the second MLD during the first SP, wherein the data frame comprises a TWT information frame indicating that the second MLD is unavailable on the first link; and
in response to the reception of the TWT information frame, transitioning the first STA to a power save mode.

18. A multi-link device (MLD), comprising:
a first station (STA) associated with a first link of a wireless network and configured to communicate with a second MLD over the first link using a multi-link target wake time (TWT) process;
a second STA associated with a second link of the wireless network and configured to communicate with the second MLD over the second link using the multi-link TWT process; and
one or more processors communicatively coupled to the first and second STAs and configured to transmit, using the first STA on the first link, a TWT information frame to the second MLD during a first service period (SP) associated with the multi-link TWT process, wherein the TWT information frame indicates availability of the first STA during a rest of the first SP and availability of the second STA during a rest of a second SP associated with the multi-link TWT process.

19. The MLD of claim 18, wherein the TWT information frame further indicate one or more other SPs associated with the multi-link TWT process after the first SP is suspended.

20. The MLD of claim 18, wherein the one or more processors are further configured to:
receive, using the first STA on the first link, a data frame from the second MLD during the first SP, wherein the data frame comprises a second TWT information frame indicating that the second MLD is unavailable on the first link; and
in response to the reception of the TWT information frame, transition the first STA to a power save mode.
